(19) United States
(12) Patent Application Publication
(10) Pub. No.: US 2026/0203428 A1
(43) Pub. Date: Jul. 16, 2026

(54) DIGITAL CONTENT COEDITING SERIALIZATION SUPPORT

(71) Applicant: Adobe Inc., San Jose, CA (US)

(72) Inventors: Michael Scott Vitrano, New York, NY (US); Tai Benjamin Luxon, San Diego, CA (US); Robert Hedin Gardner, Brooklyn, NY (US)

(73) Assignee: Adobe Inc., San Jose, CA (US)

(21) Appl. No.: 19/018,530

(22) Filed: Jan. 13, 2025

(51) Int. Cl. G06F 21/62; G06F 21/10

(52) U.S. Cl. CPC G06F 21/62; G06F 21/1062

(57) ABSTRACT

Digital content coediting techniques are described, including detecting a change in state of digital content that is maintained as part of a coediting session involving a plurality of client devices. One or more elements of the digital content are located corresponding to the change in state and a fingerprint is generated responsive to the detecting, which is based on a hash of a serialization of the one or more elements. The fingerprint is communicated for receipt by at least one of the plurality of client devices, the fingerprint configured to cause local synchronization of the digital content.

### BACKGROUND

Digital content coediting is used to support collaboration by a plurality of entities in digital content creation and editing. As part of this, techniques are utilized to resolve conflicts between edits made by different entities, e.g., as caused by concurrent edits to a same portion of the digital content.

Conventional techniques used in conflict resolution, however, are specialized and as such are typically incompatible for use with legacy applications. Further, conventional techniques are confronted with technical challenges caused by complexity in models used to define the digital content, an amount of data used to store the digital content, and so forth.

### SUMMARY

Digital content coediting techniques are described, including detecting a change in state of digital content that is maintained as part of a coediting session involving a plurality of client devices. One or more elements of the digital content are located corresponding to the change in state and a fingerprint is generated responsive to the detecting, which is based on a hash of a serialization of the one or more elements. The fingerprint is communicated for receipt by at least one of the plurality of client devices, the fingerprint is then used to determine whether the change in document state in consistent across participants in a coediting session.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ coediting techniques described herein.

FIG. 2 depicts a system in an example implementation showing operation of the first content editing module of a first client device in greater detail as generating a fingerprint responsive to detecting a change in state of digital content.

FIG. 3 depicts a system in an example implementation showing operation of the first content editing module in greater detail as making an edit to a first local version of digital content and generating a candidate edit event based on the edit.

FIG. 4 depicts a user interface that is output that is configured to edit digital content configured as a digital image.

FIG. 5 is a flow diagram depicting an algorithm as a step-by-step procedure in an example implementation of operations performable for accomplishing a result of fingerprint generation as describing a change in state to digital content responsive to an edit to the digital content.

FIG. 6 depicts a system in an example implementation of fingerprint synchronization by a coediting system as part of a coediting session between first and second client devices of FIG. 1.

FIG. 7 depicts an architecture in an example implementation showing a compatibility determination for named, dynamic, and backward compatible scenarios.

FIG. 8 depicts an architecture in an example implementation showing a compatibility determination for a transition build to determine compatibility, including bi-directional compatibility, between client devices.

FIG. 9 depicts an architecture of a document object model in an example implementation showing in-memory document model data structures for corresponding content names of content editing functionality supported by respective items of digital content.

FIG. 10 depicts an architecture of named content detection in an example implementation by a client device for named and unnamed content in a document as an example of digital content.

FIG. 11 depicts an architecture configured to support changing a classification of previously incompatible digital content to compatible digital content.

FIG. 12 depicts an architecture configured to support a change in classification of previously incompatible digital content to compatible digital content.

FIG. 13 is a flow diagram depicting an algorithm as a step-by-step procedure in an example implementation of operations performable for accomplishing a result of mode implementation based on detector modules to control interaction with a coediting session.

FIG. 14 depicts an architecture configured to support an evolving document model as part of named content evolution.

FIG. 15 depicts an architecture configured to support control of loading and execution of digital content upon detecting unknown named content.

FIG. 16 depicts a timeline progression showing release coordination involving a coordinated release of a breaking change involving producer and consumer releases.

FIG. 17 depicts an example implementation of a deprecation and expiration technique for client device support in a coediting system.

FIG. 18 depicts an example implementation of delta detection from a deprecated client that are not to be process in a coediting system.

FIG. 19 depicts a system in an example implementation depicting techniques for offline editing of digital content that is shared as part of a coediting session.

FIGS. 20, 21, and 22 depict examples of a user interface in example implementations as involving an edit history for collaborative digital content that are implementable utilizing the described systems and devices.

FIG. 23 is a flow diagram depicting an algorithm as a step-by-step procedure in an example implementation of operations performable for accomplishing a result of fingerprint generation responsive to a change in state.

FIG. 24 is a flow diagram depicting an algorithm as a step-by-step procedure in an example implementation of operations performable for accomplishing a result of use of version identifiers to control synchronization as part of collaborative editing of digital content.

FIG. 25 is a flow diagram depicting an algorithm as a step-by-step procedure in an example implementation of operations performable for accomplishing a result of offline synchronization as part of collaborative editing.

FIG. 26 is a flow diagram depicting an algorithm as a step-by-step procedure in an example implementation of operations performable for accomplishing a result of mismatch resolution in a coediting environment.

FIG. 27 illustrates an example system generally at that includes an example computing device that is representative of one or more computing systems and/or devices that implement the various techniques described herein.

### DETAILED DESCRIPTION

### Overview

Digital content coediting is used to support concurrent editing by multiple entities (e.g., via respective client devices) with a single item of digital content, which is also referred to simply as a “document” in the following discussion. During a digital content editing session, for instance, changes made by entities to the digital content are communicated (e.g., in real time) between client devices employed by the entities to support collaboration. In some instances, however, conflicts may occur between changes made by the entities, e.g., different edits to a same portion of the digital content that are made at approximately the same time before those edits may be communicated between the client devices.

Conventional techniques used as part of conflict resolution, however, are specialized and therefore lack compatibility with legacy applications and object models employed by those applications. Further, conventional conflict resolution techniques encounter inefficiencies caused by complex items of digital content and/or that consume significant amounts of data storage. As a result, conventional conflict resolution techniques as employed in digital content coediting encounter computational and network inefficiencies, increased power consumption, and limited applicability.

Accordingly, digital content coediting techniques are described. These techniques support coediting functionality to legacy applications and complex object models. The digital content coediting techniques also support improved computational efficiency and reduced power consumption for items of digital content that consume significant amounts of data storage, e.g., for large digital images having multiple layers, each supporting a multitude of pixels.

In one or more examples, a coediting system supports collaborative editing of digital content by serializing content changes into deltas for exchange between client devices. In one or more implementations, the deltas include “fingerprints” generated for respective elements in the digital content (e.g., from an associated document object model) that are subject to a change in state.

The “deltas” act as a container of information that includes a description of a change in document state as a result of a client device's edit. These deltas are communicated through the service provider system to each of the connected client devices, which then parse the deltas and use the enclosed information to apply the edit made by the other client devices. The deltas also include metadata about things like who is the author and conflict management details.

In one or more implementations, an additional set of metadata is included in the delta to enable the client device that applies the delta to verify a same document state has been achieved as an author of that delta. This metadata is a set of “fingerprints” that encode a state of each of the “elements” of the digital content that were modified as part of the change that the delta describes. For each element modified in the document, a hash is performed over a serialization of the element that may strip away client/session specific data to arrive at a compact fingerprint of the content of that element. Stripping the client/session specific data protects against an inconsistent hash calculation across client devices and time-based considerations.

The set of fingerprints per element are encoded into the delta. When each client device receives a delta, the client device first applies the encoded change to a local copy of the digital content and then compute the same hash fingerprint on their local copy of the affected elements. The client device then compares the locally computed fingerprints against the ones encoded in the delta to determine if there is a mismatch between the document states of the local client and the client device that originated the change.

On detecting a mismatch, there is either a bug in our fingerprinting mechanism or the serialization/replay workflow for coediting. Therefore, the coediting system is configurable to log the appropriate analytics and diagnostics back to the engineering team to be alerted to bugs happening in the field without involving active user intervention. Additionally, the coediting system can automatically recover by requesting that a synchronization module act as an arbiter of a correct document state by applying the delta itself and computing the fingerprints to see what the “correct” state should be. The synchronization module can then broadcast its calculated states and each connected client who computed a different set of fingerprints to then reload the digital content from the synchronization service to “get back in sync” with the agreed upon state of the digital content as indicated by the synchronization module.

The coediting system, in one or more examples, manages compatibility between client devices with varying capabilities by versioning deltas and implementing backward-compatible deserialization. For example, a new named delta version is introduced and associated with a feature flag usable to control enablement of corresponding content editing functionality when production-ready changes are made to coediting serialization, with which, older client devices are incompatible. New serialization code, in one or more implementations, executes solely when a corresponding named delta version (e.g., for a respective content feature) is enabled, thereby supporting controlled introduction of “breaking changes” (i.e., changes that are potentially disruptive to further operation) independent of code merging into a form that is released for general consumption by the public.

Deserialization code, however, remains available regardless of feature flag status, ensuring backward compatibility. The coediting system, for instance, maintains existing deserialization support when modifying serializations, enabling processing of deltas from client devices with equal or lower maximum named delta versions. During serialization, the coediting system is configurable to dynamically calculate a minimum delta version representative of utilized serializations for specific elements of digital content, writing the version into the “delta” describing a change in state. Such calculation minimizes the delta version received by consuming client devices, maximizing inter-client compatibility, and reducing observed incompatibilities.

The coediting system implements these versioning and compatibility mechanisms to address a variety of technical advantages, including detecting when client devices generate incompatible deltas, processing deltas from supported client devices, and allowing engineering teams to merge “new” serialization support without creating immediate breaking changes. By dynamically computing delta versions and supporting backward compatibility, the coediting system facilitates collaborative editing across client devices with heterogeneous capabilities while minimizing disruptions due to version mismatches.

In an example involving consistency checking, the coediting system leverages a document model divided into independently editable elements to implement cross-client device consistency checking. When a modification is made one or more elements during a single interaction, for instance, the coediting system computes a set of elements that correspond to the change in state. For each modified element, the coediting system generates a fingerprint by serializing the element into a buffer and calculating a hash. The coediting system then transmits each modified element's hash alongside the serialized change representation to other client devices.

Upon receiving a remote change, the coediting system applies the serialized modification to the local digital content on the receiving client device. Subsequently, the coediting system computes local fingerprints for each modified element and compares these fingerprints against the corresponding hashes contained in the received delta, i.e., the received fingerprint. Through comparison, the coediting system detects potential inconsistencies between client devices, ensuring data integrity across the collaborative editing environment.

The coediting system, in one or more examples, incorporates a cloud-based component by a service provider system that is responsible for coalescing incremental changes into finalized digital content versions. Acting as a coordinator for inconsistencies, the cloud component processes incoming changes and identifies fingerprint mismatches. When a mismatch is detected, the coediting system broadcasts a message to each of the connected client devices, instructing the client devices to reload the document from the latest cloud version. By implementing reload instructions, the coediting system maintains a consistent document view across each of the participating client devices, thereby mitigating against discrepancies that may arise during collaborative editing sessions.

In additional examples, the coediting system implements a draft serialization support mechanism to facilitate iterative development of coediting serialization features. The draft support mechanism, in one or more implementations, operates independently from production serialization support, in one or more implementations, thereby allowing engineering teams to refine and test new serialization methods without constraints associated with named delta versions in production environments.

The coediting system, for instance, associates draft serialization support with a draft serialization name (e.g., represented as a string) and an iteration version specific to that string. When the draft support is activated, the coediting system includes the draft serialization name and iteration version in the client device's compatibility information, which is utilized for session compatibility determinations. Additionally, the coediting system writes these identifiers into deltas alongside the standard delta version. The coediting system is configurable to restrict delta processing to client devices possessing matching draft serialization names and iteration versions, ensuring controlled testing and development.

Upon modifications to the draft serialization code, the coediting system increments the iteration version. The coediting system, in one or more examples, does not maintain backward compatibility for deserializing prior iterations of draft serializations, thereby streamlining the development process. By implementing draft serialization support, the coediting system enables engineering teams to rapidly iterate on serialization features, assess a corresponding amount of effectiveness, and prepare the content editing features for production deployment without impacting existing production workflows or incurring undue development overhead.

In yet further examples, the coediting system implements content compatibility detection to ensure client devices collaborate solely on items of digital content (e.g., documents) containing content compatible with each client device. The coediting system, for instance, divides unsupported content types of the document model into logical pieces, each assigned a unique name. For each piece of named content, the coediting system employs a detector capable of inspecting document states to identify the presence of specific content types. The coediting system executes these named content detectors to determine the existence of named content within digital content, enabling appropriate blocking of coediting workflows when incompatibilities are detected.

The coediting system, for instance, categorizes named content based on edit serialization support status, examples of which include “enabled,” “disabled,” or “unsupported.” “Enabled” status signifies full coediting compatibility, exempting the associated detector from compatibility checks. “Disabled” status indicates “consume solely” compatibility, with the detector executed solely when evaluating document conversion to coediting format or content introduction into coediting documents. “Unsupported” status denotes coediting incompatibility, and therefore causing detector execution for each of the content detector modules for compatibility checking workflows.

To accommodate document model expansion over time, the coediting system is configurable to implement a mechanism to restrict “older” client devices (e.g., having older code versions) from collaborating on items of digital content containing unrecognized content. During document saving operations, for instance, the coediting system executes each of the named content detector modules on respective client devices and records a comprehensive list of detected named content within the digital content. Upon opening the digital content, the coediting system directs client devices to examine the recorded list for unfamiliar entries. The presence of unknown entries prompts the coediting system to designate the digital content as incompatible for coediting on that particular client device, maintaining collaborative integrity across varying client device capabilities.

The coediting system is also configurable to implement a variety of edit history enhancements. The coediting system, for instance, implements cloud-based persistent edit history functionality to enhance collaborative document editing. The coediting system stores deltas, representing incremental document changes, and periodic asset versions, capturing full document states after edit sets, in cloud storage. When a client device requests an edit history that is unavailable locally (e.g., from previous editing sessions or collaborator edits prior to joining), for instance, the coediting system loads an asset version at or before the desired history state. The coediting system then retrieves and applies subsequent deltas to reconstruct the edit history. The reconstructed history becomes accessible through standard history user interfaces, including history scrubbing features.

For local document editing, the coediting system extends persistent history support by leveraging the coediting delta mechanism. During local file editing, the coediting system generates “reverse” deltas, representing changes from post-edit to pre-edit states. The coediting system stores these reverse deltas within or alongside the local file during save operations, or in a device cache upon generation. When reopening a file, the coediting system locates available reverse deltas and applies the reverse deltas to the digital content from newest to oldest, recreating older edit history states in reverse chronological order.

The coediting system's persistent edit history functionality addresses limitations of conventional editing techniques, where edit history typically vanishes upon document closure or becomes limited due to performance constraints. By implementing cloud-based storage for collaborative documents and reverse delta generation for local files, the coediting system provides enhanced edit history persistence across various editing scenarios, improving user experience and workflow continuity.

In further examples, the coediting system facilitates offline editing of collaborative digital content by implementing an opportunistic synchronization mechanism. The coediting system allows modifications to digital content while offline, preserving both original and edited versions upon digital content and/or application closure. Subsequently, the coediting system prepares the edited version for synchronization via a background process, which activates upon device reconnection, independent of a primary editing application's status, i.e., a content editing module. The background process employs a generic approach, managing file uploads with basic if/match conflict detection. In scenarios without concurrent edits during the offline period, the background synchronization completes successfully, updating the cloud version for access by other client devices.

When an if/match conflict occurs due to changes from other client devices, the coediting system is configurable to initiate a three-way merge process upon document reopening. The merge operation, in one or more examples, utilizes an original (base) version, the locally modified version, and the latest cloud version of the digital content. The coediting system employs an incremental, delta-based synchronization technique to integrate offline edits into the shared cloud document. By combining generic file-based synchronization with incremental delta synchronization, the coediting system achieves rapid offline change integration when conflicts are absent while maintaining capability for sophisticated merging upon document reopening.

The coediting system's approach to offline editing and synchronization enhances collaborative workflows by enabling seamless work in disconnected environments. Through implementation of background synchronization and conflict resolution mechanisms, the coediting system minimizes disruptions to productivity and ensures data consistency across multiple editing sessions and client devices. The coediting system's ability to perform both immediate background synchronizations and delayed sophisticated merges provides a flexible and robust solution for managing offline edits in collaborative document environments.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Coediting Environment

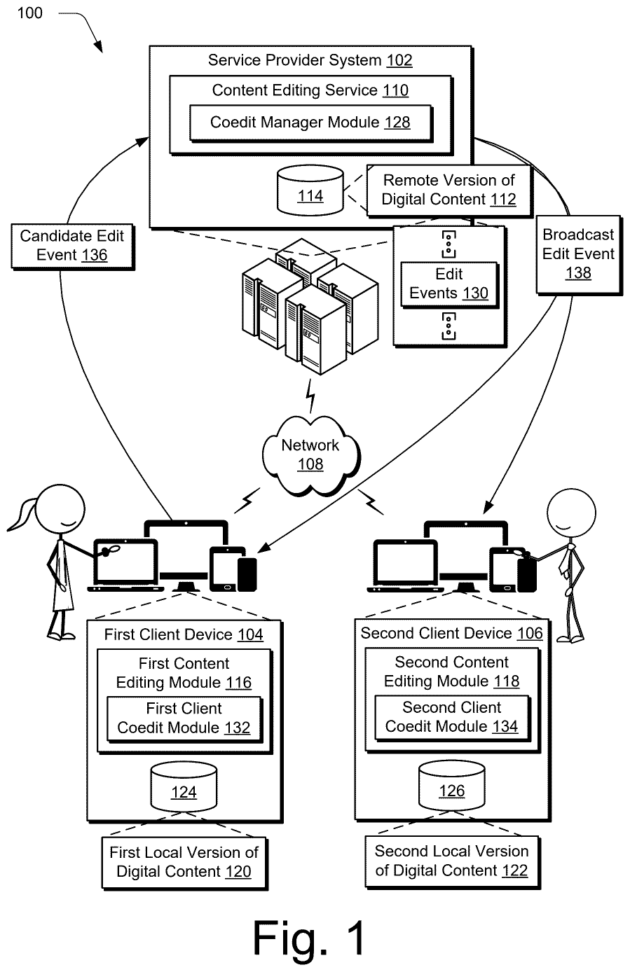

FIG. 1 is an illustration of a digital medium environment 100 in an example implementation that is operable to employ digital content coediting and conflict resolution techniques described herein. The illustrated environment 100 includes a service provider system 102, a first client device 104, and a second client device 106 that are communicatively coupled, one to another, via a network 108, e.g., the Internet. Computing devices that implement the service provider system 102 and the first and second client devices 104, 106 are configurable in a variety of ways.

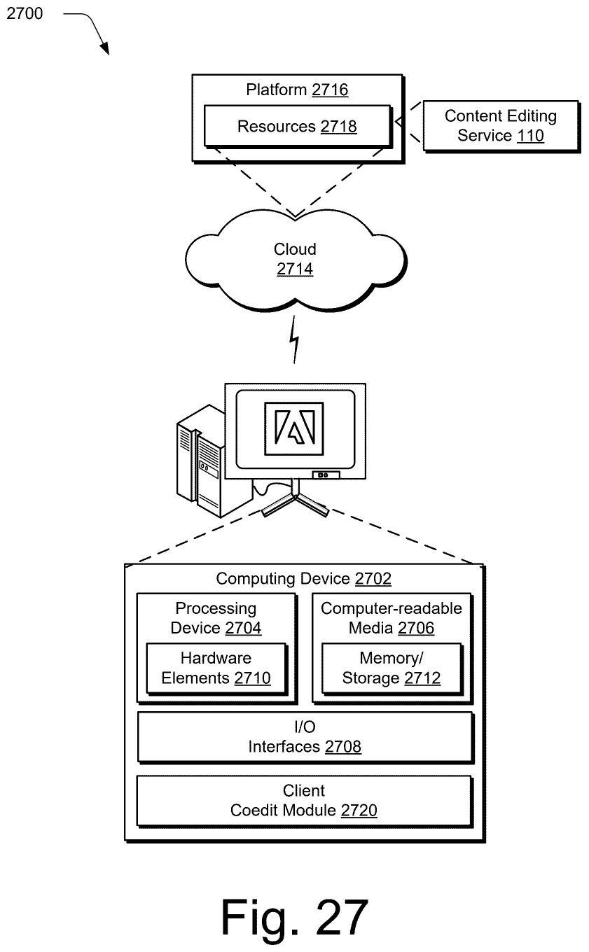

Computing devices, for instance, are configurable as a desktop computer, a laptop computer, a mobile device (e.g., assuming a handheld configuration such as a tablet or mobile phone), and so forth. Thus, computing devices range from full resource devices with substantial memory and processor resources (e.g., personal computers, game consoles) to a low-resource device with limited memory and/or processing resources (e.g., mobile devices). Additionally, although a single computing device is shown and described, a computing device is also representative of a plurality of different devices, such as multiple servers utilized by a business to perform operations “over the cloud” as described in FIG. 27.

The service provider system 102 is illustrated as including a content editing service 110 that is configured to support digital content coediting between the first and second client devices 104, 106 over the network 108 as part of a content editing system. The content editing service 110, for instance is illustrated as maintaining a remote version of digital content 112 in a storage device 114. The first client device 104 and the second client device 106 include, respectively, a first content editing module 116 and a second content editing module 118. Accordingly, in the following discussion operations described generally as being performed by the content editing system may be performed by the content editing service 110, the first content editing module 116, the second content editing module 118, and so on.

The first and second content editing modules 116, 118 are configured to edit, respectively, a first local version of digital content 120 and a second local version of digital content 122, which are illustrated as maintained in respective local storage devices 124, 126. The digital content is configurable in a variety of ways, such as a digital image, digital document, digital video, digital audio, and so forth. Accordingly, a variety of edits are also supported by the first and second content editing modules 116, 118, e.g., to change color values of pixels in a digital image, a spectrogram of digital audio, frames of a digital video, words in a digital document, and so forth.

The content editing service 110 includes a coedit manager module 128 that is representation of functionality to implement a coediting session between the first and second client devices 104, 106. A coediting session supports an ability for multiple entities to edit a same item of digital content during a same session, e.g., simultaneously in real time or near real time. To do so in this example, the coedit manager module 128 employs edit events 130 that describe edits made to local versions of the digital content and corresponding changes in state to the digital content. The edit events 130 are generated and utilized by a first client coedit module 132 and a second client coedit module 134 to control which edits are permitted to respective local versions of the digital content and resolve conflicts.

A first content editing module 116 in the illustrated example makes an edit to a first local version of the digital content 120. Digital content 120 is configurable in a variety of ways, examples of which include digital images, digital documents, presentations, digital media, digital audio, and so forth. In response, the first client coedit module 132 generates a candidate edit event 136 that is communicated to the service provider system 102 via the network 108. The coedit manager module 128 is configurable to implement a strict ordering of edit events as received by the coediting system from respective client devices, which are then broadcast in that order as a broadcast edit event 138, e.g., both to the first client device 104 that generated the candidate edit event 136 as well as the second client device 106. The first and second client coedit modules 132, 134 are then tasked with detecting conflicts and applying the edits, and thus is performed locally by the respective client devices for the first and second local versions of the digital content 120, 122 in this example.

In this way, use of the edit events 130 and orderings imposed by the coedit manager module 128 and conflict resolution implemented locally by the first and second client coedit modules 132, 134. The conflict resolution techniques support live coediting functionality that may be retroactively applied to legacy applications and support use of complex document models, which is not possible in conventional techniques as further described below. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Content Coediting Fingerprint Generation

The following discussion describes fingerprint generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform algorithm.

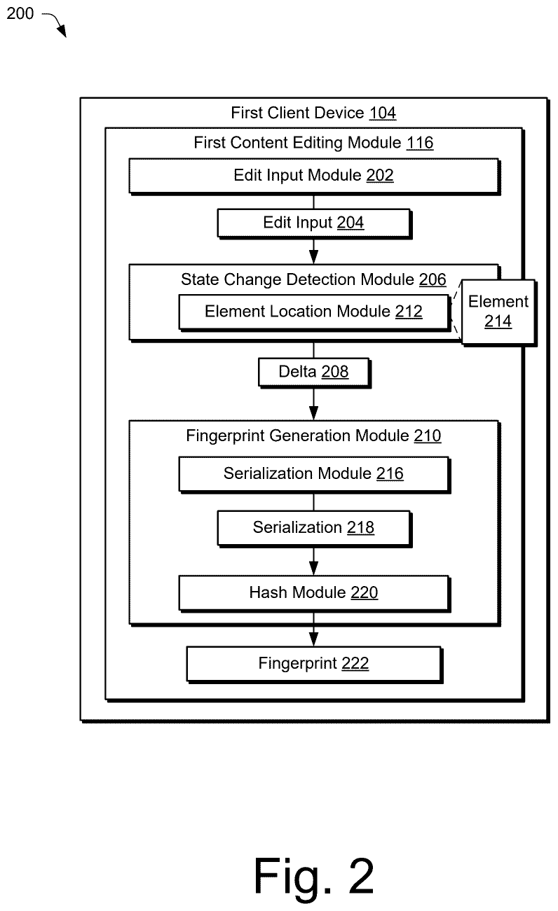

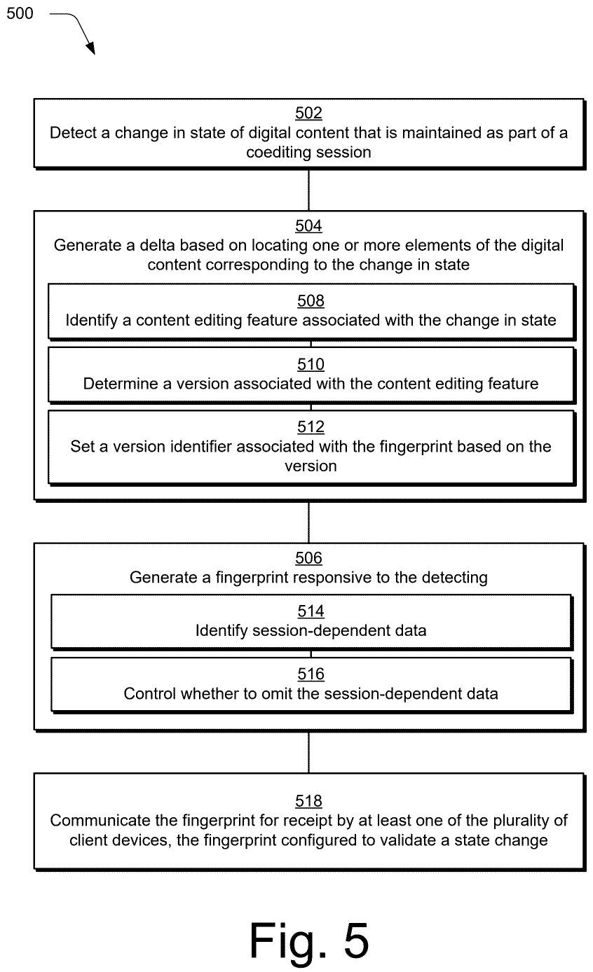

FIG. 2 depicts a system 200 in an example implementation showing operation of the first content editing module 116 of the first client device 104 in greater detail as generating a fingerprint responsive to detecting a change in state of digital content. FIG. 5 is a flow diagram depicting an algorithm 500 as a step-by-step procedure in an example implementation of operations performable for accomplishing a result of fingerprint generation as describing a change in state to digital content responsive to an edit to the digital content.

As previously described, the coediting system supports collaborative editing of digital content by serializing content or changes into deltas for exchange between client devices. When integrating coediting capabilities into applications with complex legacy document models, for instance, the coediting system balances implementing serialization support for existing document content types against enhancing other aspects of the collaborative editing experience. As a result, the coediting system may not initially support each instance of editing functionality as part of collaboration but expands support incrementally over time. The coediting system also accommodates evolution of an underlying document model, adapting to incorporate new content types and structures as they emerge in future iterations of the application.

To support this functionality, deltas are generated that describe a “” change in state of underlying digital content, e.g., responsive to an edit made to the digital content using corresponding content editing functionality. In this way, the coediting system supports several technical advantages related to serialization compatibility and evolution. The coediting system, for example, implements mechanisms to detect when a client device generates a delta containing content serialization that is incomprehensible to other client devices.

In a “live” coediting session involving multiple client devices, each client device includes a local version (e.g., in-memory) of digital content. Despite potential variations in document states due to differing edit application orders, the coediting system ensures eventual content consistency. To maintain customer confidence, the coediting system is configured to act as a guide such that each client device achieves a consistent document state relative to other client devices and aligns with persistent storage.

In an example involving consistency checking, the coediting system leverages a document model divided into independently editable elements to implements cross-client device consistency checking. When a modification is made one or more elements during a single interaction, for instance, the coediting system computes a set of elements that correspond to the change in state. For each modified element, the coediting system generates a fingerprint by serializing the element into a buffer and calculating a hash. The coediting system then transmits each modified element's hash alongside the serialized change representation to other client devices as part of the delta.

Upon receiving a remote change, the coediting system applies the serialized modification to the local digital content on the receiving client device. Subsequently, the coediting system computes local fingerprints for each modified element and compares these fingerprints against the corresponding hashes contained in the received delta. Through comparison, the coediting system detects potential inconsistencies between client devices, ensuring data integrity across the collaborative editing environment.

The coediting system, in one or more examples, incorporates a cloud-based component by a service provider system that is responsible for coalescing incremental changes into finalized digital content versions. Acting as a coordinator for inconsistencies, the cloud component processes incoming changes and identifies fingerprint mismatches. When a mismatch is detected, the coediting system broadcasts a message to each of the connected client devices, instructing the client devices to reload the document from the latest cloud version. By implementing reload instructions, the coediting system maintains a consistent document view across each of the participating client devices, thereby mitigating against discrepancies that may arise during collaborative editing sessions.

The coediting system, for instance, is configurable to implement a cross-client Document Consistency Checking (DCC) mechanism to detect unexpected state inconsistencies, enabling user notification and recovery to a consistent state, while also identifying bugs for improved Live Coediting (LCE) system reliability. The coediting system has developed a mechanism for computing a fingerprint of each client's in-memory document model (ImageState) that describes the state of the digital content after an edit. The coediting system is also configurable to synchronize and compare these fingerprints to validate document consistency, with mismatches indicating inconsistencies between clients.

In the illustrated example, an edit input module 202 is configured to detect an edit input 204, e.g., using corresponding content edit functionality. In response, a delta generation module 206 in the illustrated example then generates a delta 208 based on a changed state caused by the edit, e.g., to underlying elements of a document object model of the digital content. In other words, the editing input 204 causes detection of a change in state of digital content that is maintained as part of a coediting session (block 502). The change in state is then used as a basis to generate a delta including elements of the digital content corresponding to the change in state.

A fingerprint generation module 210 is then employed to generate a fingerprint 222 that describes a corresponding “delta” 208 corresponding to the change in state. To do so, the state change detection module 206 employs an element location module 212 that is configured to locate an element 214 in a document object model corresponding to the change in state (block 504), i.e., that is a subject of the editing input and is described using the delta 208. A fingerprint is then generated by the fingerprint generation module 210 responsive to the detecting of the change in state (block 506). A serialization module 216, for instance, is employed to serialize the element 214 (e.g., from an in-memory stream of the element 214 from the delta 208) and a hash module 220 computes a hash of the serialization 218 to generate the fingerprint 222. The fingerprint 222 is then communicated for receipt by at least one of a plurality of client devices to validate a state change (block 518) by each of the client devices that participate in the coediting session.

In this way, the state change detection module 206 as generating the delta 208 and the fingerprint generation module 210 as generating the fingerprint 222 supporting a variety of technical advantages. The fingerprint 222, for instance, supports document model coverage to ensure detection of potential inconsistencies across the document model. Second, the fingerprint 222 is reliable, such that the fingerprint generation module 210 consistently produces a same fingerprint value for identical document content. Third, fingerprint 222 is performant and as such supports frequent computation of the fingerprint for comparison after each change in state of the digital content.

To compute the fingerprint 222, in one or more examples, the fingerprint generation module 210 writes elements of the digital content into an in-memory stream and then computes a hash over the written contents, e.g., using MD5, SHA1, and so forth. For sub-components (e.g., a sheet's vector mask or blending options), the fingerprint generation module 210 leverages serialization code for the relevant types to write corresponding elements into the stream. Scenarios may be encountered in which serialization functions include data that may be session dependent, such as a local integer sheet ID. To handle these varying local values, the fingerprint generation module 210 implements a parameter in the serialization functions to control whether to omit the session-dependent data from the fingerprint 222.

In additional examples, as part of generating the delta 208, the state change detection module 206 identifies a content editing feature associated with the change in state (block 508) and determines a version associated with the content editing feature (block 510). A version identifier is set as associated with the delta based on the version (block 512). Further discussion of this example is included in the discussion below.

Likewise, in another example the fingerprint generation module 210 is configured to identify session-dependent data (block 514) and control whether to omit the session-dependent data (block 516) as previously described, e.g., based on whether the session-dependent data is likely to cause a mismatch in fingerprints that is not resolvable by respective entities.

The coediting system, for instance, manages compatibility between client devices with varying capabilities by versioning deltas and implementing backward-compatible deserialization. For example, a new named delta version may be introduced and associated with a feature flag usable to control enablement of corresponding content editing functionality when production-ready changes are made to coediting serialization, with which, older client devices are incompatible. New serialization code, in one or more implementations, executes solely when a corresponding named delta version (e.g., for a respective content feature) is enabled, thereby supporting controlled introduction of “breaking changes” (i.e., changes that are potentially disruptive to further operation) independent of code merging into a form that is released for general consumption by the public.

Deserialization code, however, remains available regardless of feature flag status, ensuring backward compatibility. The coediting system, for instance, maintains existing deserialization support when modifying serializations, enabling processing of deltas from client devices with equal or lower maximum named delta versions. During serialization, the coediting system is configurable to dynamically calculate a minimum delta version representative of utilized serializations for specific elements of digital content, writing the version into a “delta” describing a change in state. Such calculation minimizes the delta version received by consuming client devices, maximizing inter-client compatibility, and reducing observed incompatibilities.

The coediting system implements these versioning and compatibility mechanisms to address a variety of technical advantages, including detecting when client devices generate incompatible deltas, processing deltas from supported client devices, and allowing engineering teams to merge “new” serialization support without creating immediate breaking changes. By dynamically computing delta versions and supporting backward compatibility, the coediting system facilitates collaborative editing across client devices with heterogeneous capabilities while minimizing disruptions due to version mismatches.

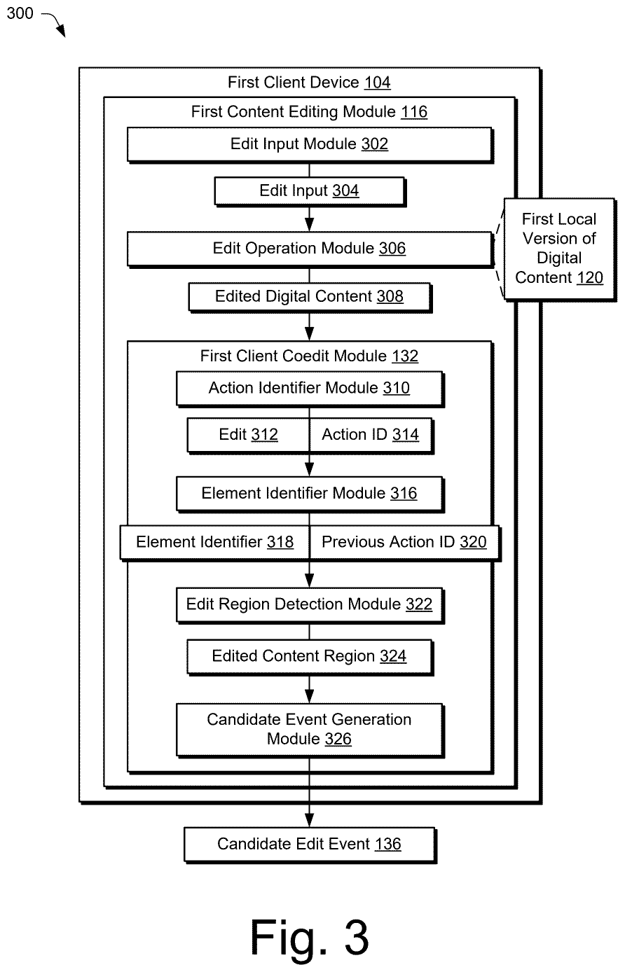

FIG. 3 depicts a system 300 in an example implementation showing operation of the first content editing module 116 in greater detail as making an edit to a first local version of digital content 120 and generating a candidate edit event 136 based on the edit. The candidate edit event 136 in this example is operable as being a basis to form the fingerprint 222 of FIG. 2.

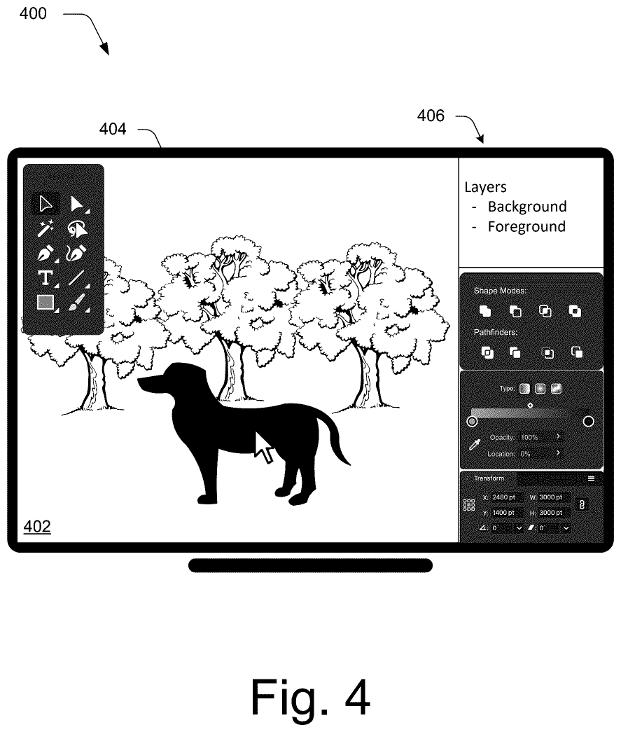

To begin in this example, an edit input module 302 receives an edit input 204. The edit input specifies an edit to digital content. As shown in an example implementation 400 of FIG. 4, for instance, a user interface 402 is output that is configured to edit digital content configured as a digital image 404. The digital image 404 includes a plurality of layers 406 and the user interface 402 includes a plurality of representations of edit operations that are applicable to the digital image 404 to change color values of respective pixels that form the digital image 404. A user input, for instance, is received through manipulation of a cursor control device to select a digital object (e.g., a dog) and edit visual characteristics of the digital object, e.g., to change a color, location, rotation, size, and so forth.

Returning again to FIG. 3, the edit input 304 is received by the edit operation module 306 and used to form edited digital content 308 from a first local version of digital content 120. The edit operation module 306, for instance, initiates the edit operation as selected by the edit input 304. The edited digital content is then passed as an input to a first client coedit module 132 to implement digital content coediting as part of a coediting session with another client device, e.g., the second client device 106.

The first client coedit module 132 begins in this example by utilizing an action identifier module 310 to identify the edit 312 and assign an action identifier (e.g., illustrated as action ID 314) to the edit 312. The edit 312, for instance, describes the edit input 304 that is received to generate the edited digital content in response to the changed state. In an implementation, the edit 312 is specified as a patch as part of a delta computed to optimize processing speed and network communication as further described below.

An element identifier module 316 is then employed to obtain an element identifier 318 of an element of the digital content that is a subject of the edit of the element and a previous action identifier 320 identifying a previous edit associated with the element. The element identifier module 316, for instance, detects an element that is a subject of the edit input 304, e.g., a layer of a digital image, page of a digital document, and so forth. The element identifier 318 is therefore used to identify that element. The previous action identifier 320 identifies a most recent edit made to that element, and as such, describes a state of the element that is a subject of the edit and therefore “what” is being edited by the edit 312.

In an implementation, an edit region detection module 322 is also employed to detect an edited content region 324 of the digital content corresponding to the edit 312. For example, the edit region detection module 322 employs tile-based incremental synchronization of pixel data in a coediting session which reduces an amount of data to be communicated and processed by respective service provider systems and client devices. To do so, the edit region detection module 322 detects which subregion of the elements (e.g., layers) are a subject of the edit 312 and generates the edited content region 324 as a subregion of the element that is changed.

In some instances, substantial amounts of data are synchronized as part of a digital content coediting session, such as to send pixel data for coediting of layers of a digital image. To address these technical challenges, the edit region detection module 322 is also configurable to employ “delta” techniques that are usable to improve computational and storage efficiency and reduce power consumption. The delta is generated by the edit region detection module 322 between a before-state of an in-memory representation of the digital content before the edit and an after-state of the in-memory representation of the digital content after the edit. The delta is then split into two pieces, a patch which describes edits made to the digital content (e.g., the edit 312) and binary data referenced by the patch describing e.g., color values of pixels involved in the edit.

As part of generation of the delta, the edit region detection module 322 is also configurable to employ validation techniques in support of legacy applications, e.g., which do not have current support for correctly computing the delta for each part of an in-memory representation of the digital content, such as a document model. If an edit is made that modified a region of digital content that is not supported comparison of the in-memory representations, then the computed delta may be incorrect and the contents of the local version of the digital content and other versions of the digital content that are maintained on other client devices as part of a coediting session may be different.

To support edit event sharing in such a scenario, a delta validation technique is performed before sending the candidate edit event over the network. This technique entails creating a local copy of the digital content by the first content editing module 116 based on the state before the edit 312 was made and then applying the delta onto the copy. The original edited version of the digital content is then compared to the copy of the digital content, to which, with the generated delta is applied. If the original and copy do not match, an edit 312 has been made that is not yet supported. Therefore, the edit 312 is reverted locally by the first client coedit module 132 and is not sent to other client devices that are participating in the digital content coediting session to protect against divergence of corresponding states of the digital content.

A candidate event generation module 326 is then employed to generate the candidate edit event 136. The candidate edit event 136, for instance, includes the action ID 314, the element identifier 318, and the previous action identifier 320. The candidate edit event 136 may also include the edited content region, e.g., as an edit 312 specified via a patch and binary data corresponding to the edited content region 324. The candidate edit event 136 is then transmitted by the first client device 104 via the network 108 for receipt by the service provider system 102.

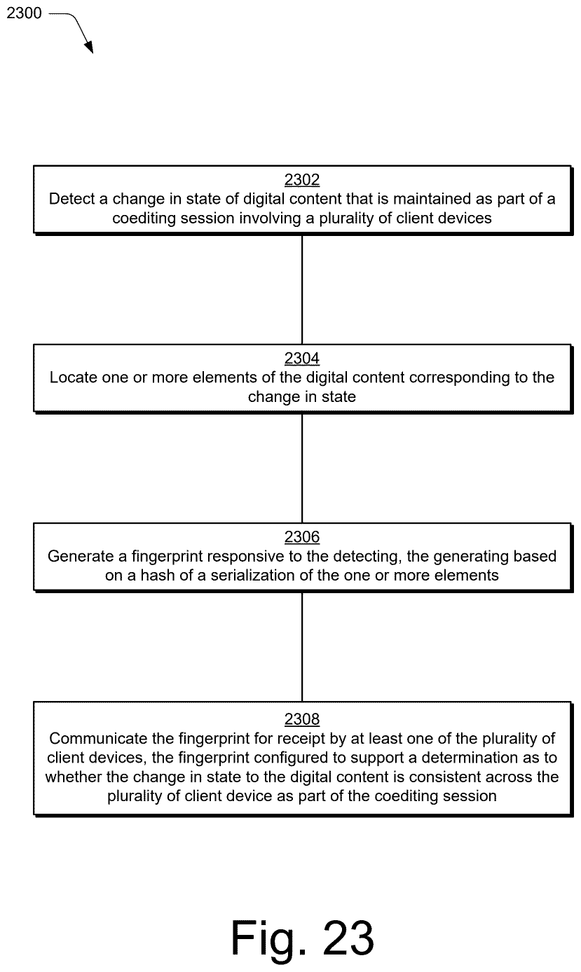

FIG. 23 is a flow diagram depicting an algorithm 2300 as a step-by-step procedure in an example implementation of operations performable for accomplishing a result of fingerprint generation responsive to a change in state. To begin in this example, a coediting system detects a change in state of digital content that is maintained as part of a coediting session involving a plurality of client devices (block 2302). The coediting system may employ an edit input module to receive an edit input specifying modifications to the digital content, such as changes to text, images, or document structure. To do so, the coediting system utilizes a state change detection module to identify alterations in the underlying elements of a document object model corresponding to the digital content. This detection process may occur in real-time or near real-time to support collaborative editing among multiple client devices participating in the coediting session.

The coediting system then locates one or more elements of the digital content corresponding to the change in state (block 2304). The coediting system may use an element location module to identify specific components of the digital content affected by the detected change. This process may involve traversing the document object model or analyzing metadata associated with the modified elements. The system may generate an element identifier for each affected element, allowing for precise tracking and synchronization of changes across the coediting session.

The coediting system further generates a fingerprint responsive to the detecting, the generating based on a hash of a serialization of the one or more elements (block 2306). The coediting system may employ a fingerprint generation module to create a unique identifier representing the current state of the modified elements. A serialization module may convert the affected elements into a standardized format, such as an in-memory stream. The coediting system may then use a hash module to compute a hash of the serialized data, producing a compact fingerprint. This process may include incorporating version information, content editing feature flags, or other metadata to ensure compatibility across different client devices.

The coediting system then communicates the fingerprint for receipt by at least one of the plurality of client devices, the fingerprint configured to support a determination as to whether the change in state to the digital content is consistent across the plurality of client device as part of the coediting session (block 2308). The coediting system may utilize a synchronization module to transmit the generated fingerprint to other client devices participating in the coediting session. The coediting system may implement efficient network protocols for distributing the fingerprint, potentially using multicast techniques or selective sending based on client device roles. Upon receipt, the fingerprint may trigger local synchronization processes on the receiving client devices, allowing the coediting system to maintain consistency across all participants in the coediting session.

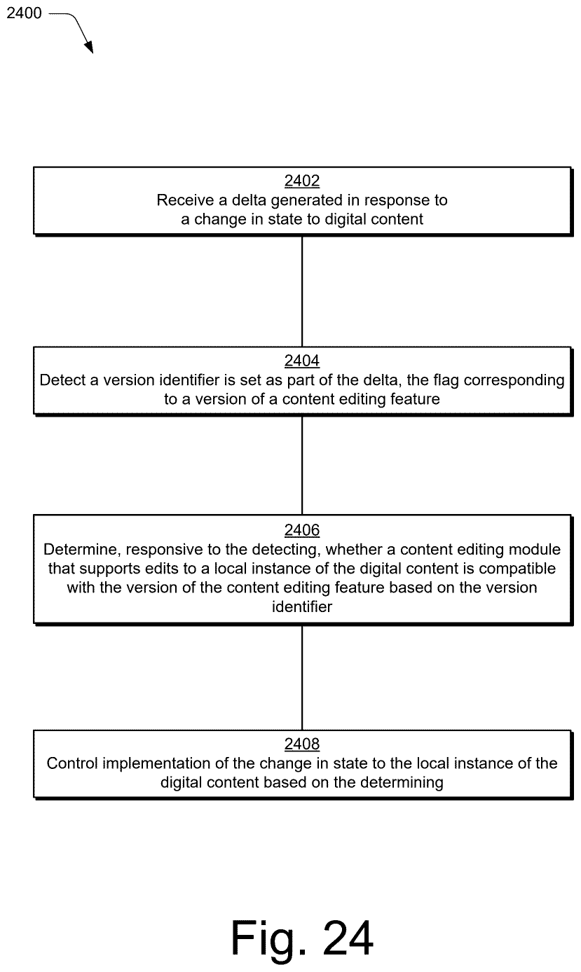

FIG. 24 is a flow diagram depicting an algorithm 2400 as a step-by-step procedure in an example implementation of operations performable for accomplishing a result of use of flags to control synchronization as part of collaborative editing of digital content. To begin in this example, a coediting system receives a fingerprint generated in response to a change in state to digital content (block 2402). The coediting system may employ a synchronization module to accept incoming fingerprints from other client devices participating in a coediting session. These fingerprints may be based on a hash of a serialization of one or more elements of the digital content corresponding to the change in state. The coediting system may process the received fingerprint to determine whether the change in document state in consistent across participants in a coediting session.

The coediting system detects a version identifier is set as part of the delta, the version identifier corresponding to a version of a content editing feature (block 2404). The coediting system, for instance, may utilize a delta analysis module to examine the received delta for embedded version identifiers or other metadata. These version identifiers may indicate specific versions of content editing features associated with the change in state. The coediting system may parse the deltas to identify and interpret these version identifiers, which is usable for determining compatibility and appropriate handling of the incoming changes.

The coediting system then determines, responsive to the detecting, whether a content editing module that supports edits to a local instance of the digital content is compatible with the version of the content editing feature based on the version identifier (block 2406). The coediting system, for instance, evaluates the detected version identifier against the capabilities of the local content editing module. This process may involve comparing the version indicated by the version identifier with the versions supported by the local system. The coediting system may consult a compatibility database or use predefined rules to assess whether the local content editing module can properly interpret and apply the changes associated with the version identifier corresponding to that content editing feature.

The coediting system controls implementation of the change in state to the local instance of the digital content based on the determining (block 2408). The coediting system, for instance, may manage the received changes for application to the local copy of the digital content. If compatibility is confirmed, the coediting system may proceed with applying the changes, potentially using delta-based synchronization techniques. In scenarios where incompatibility is detected, the coediting system may take alternative actions such as blocking the changes, displaying warnings to the user, or initiating a fallback synchronization process. This control mechanism ensures that the integrity and consistency of the local digital content are maintained while supporting collaborative editing across diverse client devices. Further discussion of use of the fingerprint is included in the following section and shown in corresponding figures.

### Consistency Checking

The following discussion describes consistency checking techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

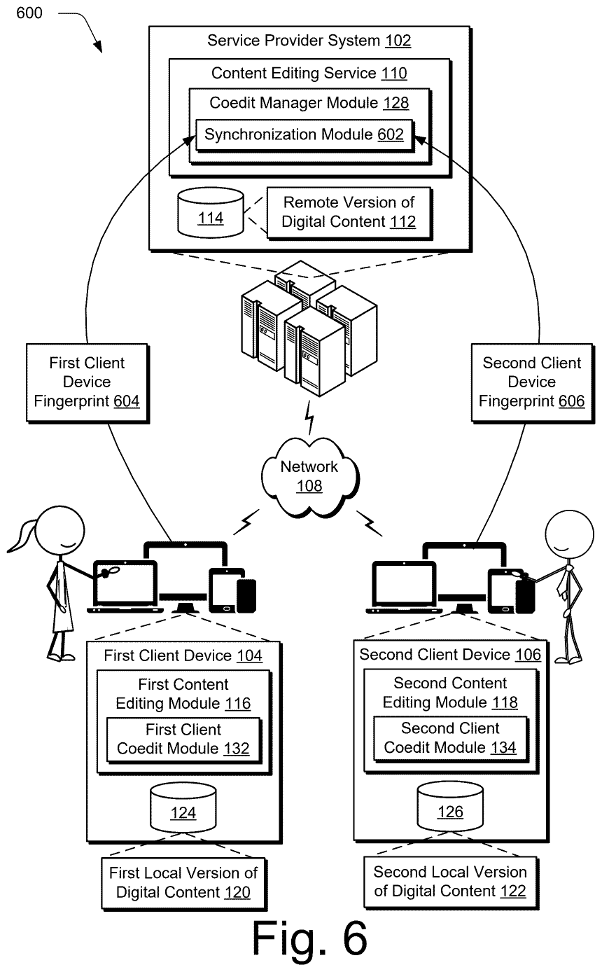

FIG. 6 depicts a system 600 in an example implementation of fingerprint synchronization by a coediting system as part of a coediting session between first and second client devices 104, 106 of FIG. 1. As previously described, deltas are generated by the coediting system (e.g., the first client coedit module 132, the second client coedit module 134, and/or the coedit manager module 128) responsive to detection of changes in state of digital content. For each element modified in a delta, a fingerprint is computed of the elements corresponding to the change in state, which are stored in the delta. Each client device participating in the coediting session also computes fingerprints for its updated elements and compares the local fingerprints against the expected values stored in the fingerprint in the delta. The synchronization module 602 of the coedit manager module 128 is then tasked with conflict resolution.

In the illustrated example, the first client coedit module 132 of the first client device 104 generates a first client device fingerprint 604 and the second client coedit module 134 of the second client device 106 generates a second client device fingerprint 606. The synchronization module 602 is then tasked with resolving a conflict, if any, to determine a “true” version of the digital content, because the coedit manager module 128 is tasked with serializing the digital content to permanent cloud storage.

Accordingly, when there is a mismatch detected, the synchronization module 602 decides whether to accept or reject a delta and its interpretation of the digital content based on a corresponding fingerprint before applying a given delta in a version of the digital content maintained “permanently” in the storage device 114 at the service provider system 102. To ensure consistency, each client device treats the interpretation by the synchronization module 602 as the correct choice. If a client device diverges from interpretation, the client device is tasked with initiating a recovery process to ensure consistency with the persisted digital content at the service provider system 102 and/or with client devices who join by opening that digital content from the remote version of the digital content 112 maintained by the service provider system 102.

To begin the recovery process, each client device that detects a fingerprint mismatch triggers a “force save” to initiate the synchronization module 602 to compute a definitive version of the digital content. The synchronization module 602 then communicates how the mismatch was arbitrated after updating the remote version of the digital content 112. In this way, the recovery process is usable to synchronize the digital content between client devices.

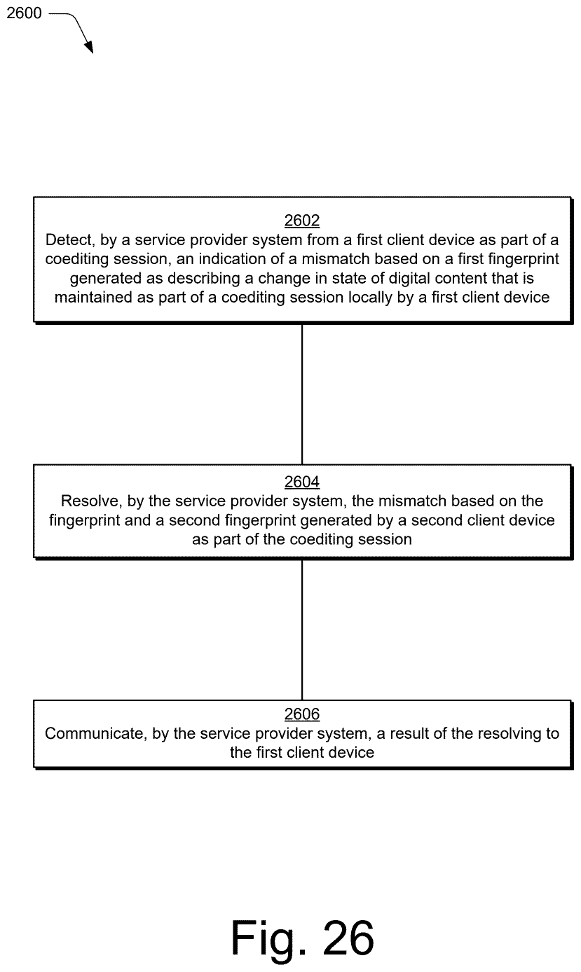

FIG. 26 is a flow diagram depicting an algorithm 2600 as a step-by-step procedure in an example implementation of operations performable for accomplishing a result of mismatch resolution in a coediting environment. A coediting system (e.g., a content manager module 128, a client coedit module, and so forth) detects a mismatch based on a first fingerprint generated as describing a change in state of digital content that is maintained as part of a coediting session locally by a first client device (block 2602). The coediting system may employ a synchronization module as a cloud service to process incoming mismatch notifications from client devices participating in the coediting session. The coediting system may analyze the received indication to extract information about the nature of the mismatch, including details about the first fingerprint and the specific elements of the digital content involved in the discrepancy. This process may involve comparing the received fingerprint against the current state of the digital content maintained by the coediting system.

A coediting system resolves the mismatch based on the fingerprint and a second fingerprint generated by a second client device as part of the coediting session (block 2604). The coediting system is configured to analyze and reconcile the discrepancies between the first and second fingerprints. This process may involve comparing the serialized representations of the affected elements, examining version information and content editing feature flags associated with each fingerprint, and applying predefined resolution rules or algorithms. The coediting system may consider factors such as timestamp, client device priorities, or specific content editing features enabled on each client to determine the correct state of the digital content.

A coediting system communicates a result of the resolving to the first client device (block 2606). The coediting system may employ a result communication module to prepare and transmit the resolution outcome to the first client device. This communication may include instructions for the first client device to update its local version of the digital content, potentially by applying specific changes or reverting to a previous state. The coediting system may also include additional metadata or explanations about the resolution process to help the client device understand and implement the changes correctly. In cases where the resolution favors the second fingerprint, the system may instruct the first client device to synchronize with the updated state of the digital content.

### Compatibility Architecture

The following discussion describes a compatibility architecture that is implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

The following discussion describes an architecture that is configurable to achieve compatibility between versions of the digital content and client coedit modules that are used to edit the versions of the digital content. The architecture supports merging of editing serialization changes and supports deltas sent by “older” client devices, i.e., client devices having previous versions of a client coedit module such as an application, plugin module, and so forth.

Negotiation techniques are implemented by the coediting system to reduce a likelihood that client devices from receive incompatible deltas during collaborative editing sessions. The coediting system, of instance, enforces participation restrictions to permit compatible client devices to enter a coediting session. Such enforcement mitigates against forcing client devices to exit sessions upon encountering incomprehensible deltas, in one or more implementations, although that implementation is also contemplated as further described below.

As described in greater detail below, forward incompatible additions or changes to edit serialization code are associated with new versions, each named and having an enabled/disabled state. Flags (also referred to as “feature flags” in the following discussion) are usable to control the utilization of these changes and drive the associated named version's state. Edit deserialization code modifications remain uncontrolled by feature flags. Existing edit deserialization support continues for backward compatibility until each of the client devices potentially generating the associated serialization have expired.

The coediting system, for example, introduces “consumer” and “producer” versions. The consumer version represents a maximum defined version, while the producer version is dynamically calculated at launch as a maximum of each of the enabled versions, reflecting a highest version the client coediting module is capable of producing. During serialization, the minimum version representative of utilized serializations for specific digital content in a delta is dynamically calculated and written into the delta. This minimizes producer versions utilized by client devices consuming the delta. Deltas are deemed compatible with a client device or the synchronization module 602 when the version is at least equal to the legacy version or up to the consumer version.

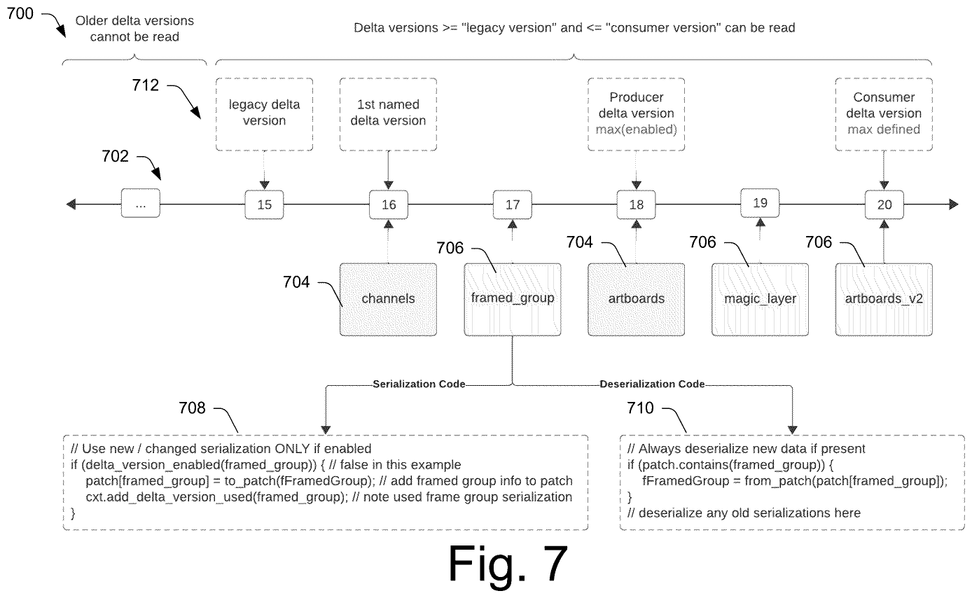

FIG. 7 depicts an architecture 700 in an example implementation showing a compatibility determination for named, dynamic, and backward compatible scenarios. The architecture 700 illustrates a delta versioning system usable for managing compatibility in the coediting system. A timeline 702 of delta versions is illustrated from “15” to “20,” with examples of content editing feature parameters including “channels”, “framed_group”, “artboards”, “magic_layer”, and “artboards_v2” associated with different version numbers. The content features are also classified as having an enabled 704 status or a disabled 706 status of respective content editing features.

Two code snippets 708, 710 are depicted showing how serialization and deserialization are handled by the coediting system in one or more examples. Serialization code, for instance, is executed solely if enabled, while deserialization code is executed each time relevant data is present. Examples 712 of different versions of client coediting modules include “legacy delta version”, “1st named delta version”, “Producer delta version max(enabled)”, and “Consumer delta version max defined,” which along with the timeline 702 defines how the coediting system manages backward compatibility between different client device versions having different content editing functionalities in this example.

In one or more implementations, the synchronization module 602 is tasked with reading versions older than a maximum defined and implement consumer logic, as the synchronization module 602 processes deltas from each of the supported client devices. Client devices may adhere to reading deltas of an exact matching version, however, version and compatibility logic is shared between the synchronization module 602 and the client devices, and therefore other implementations are also contemplated in which the logic is uniformly applied rather than maintaining separate logic.

Client devices, in one or more examples, gain advantages from reading older deltas during “catch-up” and “active editing,” thereby avoiding document reopening after persistence of the digital content by the synchronization module 602 and protecting client devices against experiencing compatibility errors when deltas from older client devices are encountered. This approach offers an improved user experience, reduces engineering effort, and reduces computational resource consumption. Additionally, “relaxed” compatibility between client devices facilitates releasing breaking changes across client devices with less coordination. “Transition builds,” for instance, may be released across client devices with breaking changes disabled, followed by builds with enabled changes. As a result, these transition builds maintain bi-directional compatibility with previous and subsequent builds.

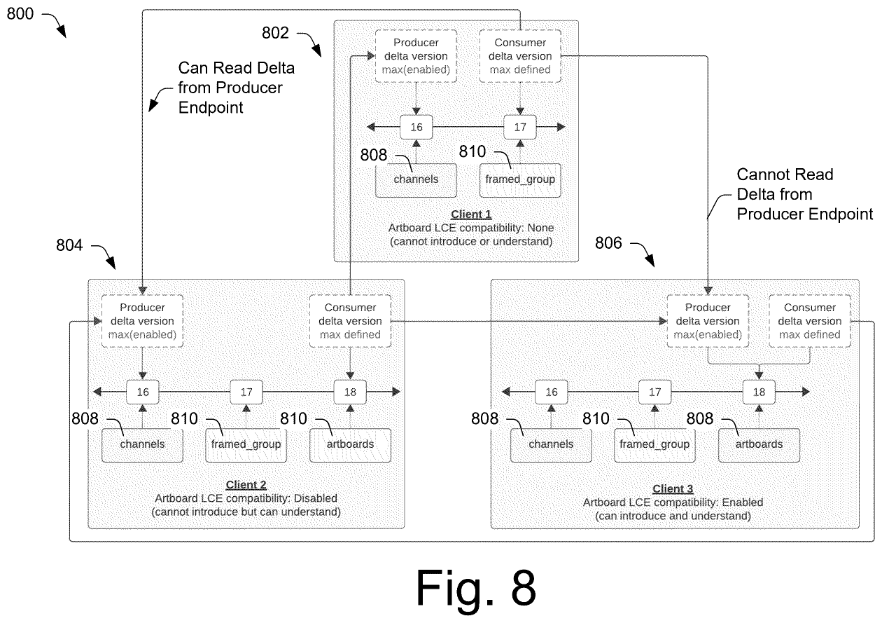

FIG. 8 depicts an architecture 800 in an example implementation showing a compatibility determination for transition build to determine compatibility, including bi-directional compatibility, between client devices. The architecture 800 illustrates a first client device 802, a second client device 804, and a third client device 806. Reference numbers are included to indicate enabled 808 and disabled 810 functionalities.

Each of the first, second, and third client devices 802, 804, 806 in this example include different producer and consumer delta version capabilities. As illustrated, each of the first, second, and third client devices 802, 804, 806 displays a respective producer delta version (max enabled) and consumer delta version (max defined), along with supported content editing features examples such as “channels”, “framed_group”, and “artboards”.

The second client device 804 is depicted as having a transition build that maintains compatibility with both the first and third client devices. Each of the client devices includes different version compatibility ranges, e.g., “16-17” for the first client device 802, “16-18” for the second client device 804, and “16-18” for the third client device 806. Each of the first, second, and third client devices 802, 804, 806 also have indications about a content editing feature of “artboard LCE compatibility status.” In the illustrated example, the second client device is fully compatible with the first client device 802 and the third client device 806. The first client device 806, on the other hand, does not have full compatibility and therefore has an inability to read some deltas produced by the third client device.

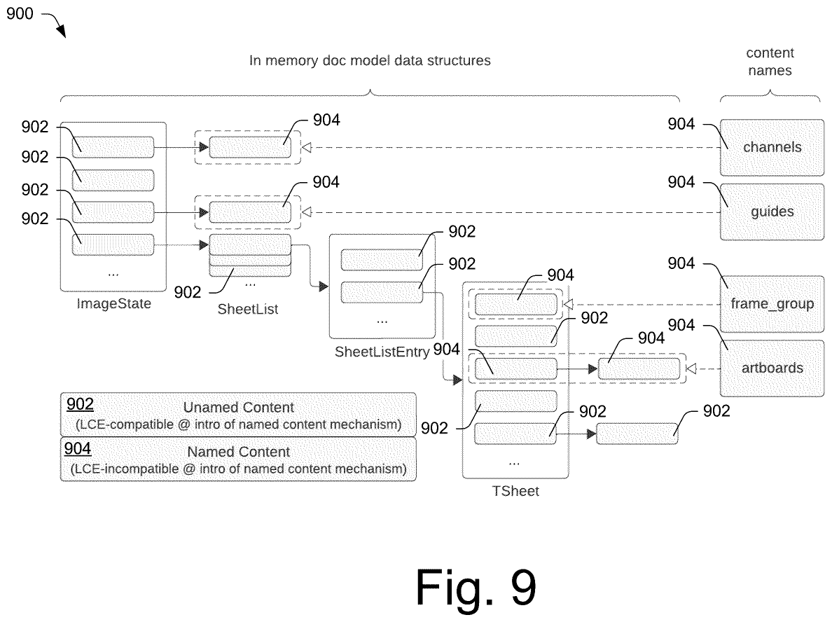

FIG. 9 depicts an architecture 900 of a document object model in an example implementation showing in memory document model data structures for corresponding content names of content editing functionality supported by respective items of digital content. The architecture 900 illustrates how a notion of “named” content editing functionality, which is also referred to as “named content” as referring to functionality of digital content itself. Accordingly, the architecture 900 includes examples of unnamed content 902 and named content as part of the document object model.

The architecture 900, for instance, depicts a structure of named document content within the in-memory document model data structures of a collaborative editing system. A hierarchical organization is presented, originating from an “ImageState” object that encompasses a “SheetList.” The “SheetList” further contains “SheetListEntry” objects, each referencing “TSheet” objects. Named content 904 elements, such as “channels”, “guides”, “frame_group”, and “artboards”, are depicted as indicating correspondence to specific components of the document structure.

This example includes two categories of content, (1) “Unnamed Content”, which is compatible with Live Collaborative Editing (LCE) upon introduction of the named content mechanism, and (2) “Named Content”, which is initially incompatible with LCE. The right-hand portion of the architecture 900 of the document object model includes a column including examples of the content names that correlate with corresponding elements within the document structure, thereby illustrating a mapping between named content and structural components.

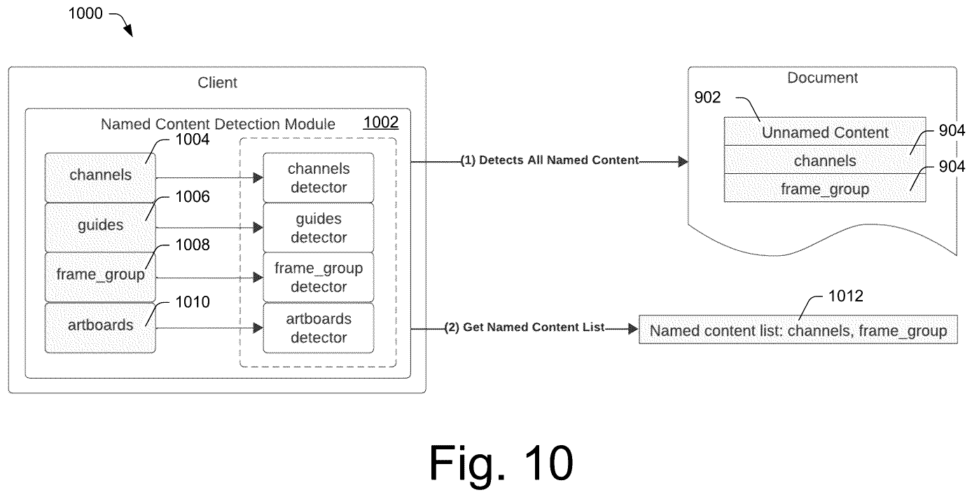

FIG. 10 depicts an architecture 1000 of named content detection in an example implementation by a client device for named and unnamed content in a document as an example of digital content. The architecture 1000 includes a client device having a named content detection module 1002 as well as examples of unnamed content 902 and named content 904.

The named content detection module 1002 includes examples of several content-specific detectors including a channel content detection module 1004, a guide content detection module 1006, a frame group content detection module 1008, and an artboards content detector module 1010.

The named content detection module 1002 is configured to detect respective types of named content by analyzing a document in the illustrated example, which includes both unnamed content 902 and named content 904. The named content detection module 1002 is configured to generate a named content list 1012 containing detected items, e.g., channels and frame group. In this way, the named content detection module 1002 is configured to systematically identify and catalog different types of content within an item of digital content using dedicated detector modules generated for each content type.

The named content detection module 1002, for instance, employs respective detector modules inspect the provided digital content and identify data associated with the specific named content. By running each detector in sequence for the set of known named content, a comprehensive list of each instance of named content present is generated.

This detection capability of the named content detection module 1002 functions to reduce a likelihood of making (e.g., prevent) an item of digital content available for coediting when incompatible elements of the digital content are present. Implementations are also contemplated to detect addition of named content following each edit, potentially blocking the addition of incompatible content in collaborative documents as a secondary safeguard to the user interface. This approach also functions to ensure compatibility and maintains the integrity of collaborative editing sessions across different client devices.

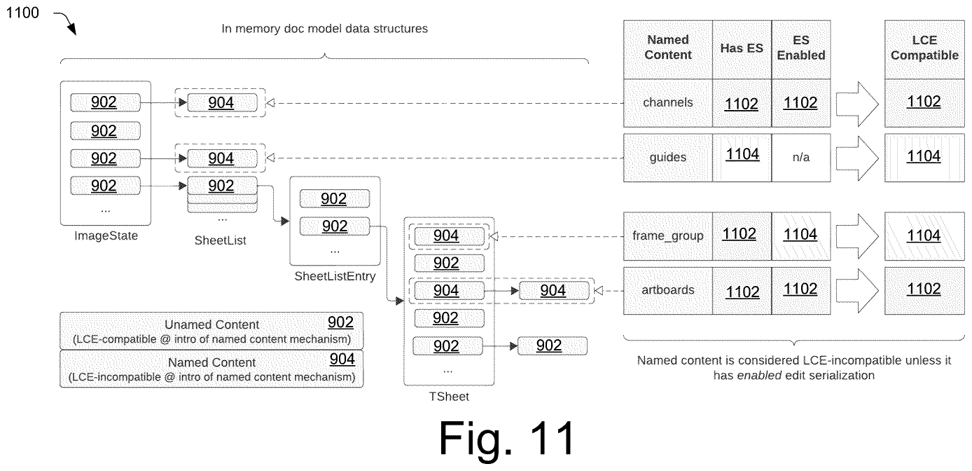

FIG. 11 depicts an architecture 1100 configured to support changing a classification of previously incompatible digital content to compatible digital content. FIG. 11 includes reference numbers indicating enabled 1102 and disable 1104 states of corresponding functionalities. The document model support of the previous figures is expanded in this example to transform previously incompatible content into compatible content. This transformation is based on this example on the addition of edit serialization support. The ability to merge edit serialization changes to the main branch in an “OFF” state without compromising compatibility is implemented through dynamic calculation of the version. Consequently, compatibility status of previously incompatible content becomes dynamic, contingent on enablement of the relevant edit serialization addition. Client devices, for instance, are configurable to determine if named content is incompatible based on the current application configuration. In scenarios where a first client device has named content “foo” enabled, for instance, content added to a coediting digital content is treated as incompatible by a second client device, which has “foo” classified as incompatible.

To address these considerations, the coediting system may employ a variety of approaches. In one such example, for each named content, presence of enabled edit serialization support is indicated. From this information, the coediting system derives whether the named content is to be considered incompatible. When opening a coediting document, detector modules for each of the incompatible named content are executed, and document opening is blocked if incompatible content is detected. This mechanism ensures that client devices can appropriately handle content based on their current configuration and capabilities, maintaining the integrity of a collaborative editing process of a coediting session as implemented by the coediting system.

The coediting system, for instance, implements a draft serialization support mechanism to facilitate iterative development of coediting serialization features. The draft support mechanism, in one or more implementations, operates independently from production serialization support, in one or more implementations, thereby allowing engineering teams to refine and test new serialization methods without constraints associated with named delta versions in production environments.

The coediting system, for instance, associates draft serialization support with a draft serialization name (e.g., represented as a string) and an iteration version specific to that string. When the draft support is activated, the coediting system includes the draft serialization name and iteration version in the client device's compatibility information, which is utilized for session compatibility determinations. Additionally, the coediting system writes these identifiers into deltas alongside the standard delta version. The coediting system is configurable to restrict delta processing to client devices possessing matching draft serialization names and iteration versions, ensuring controlled testing and development.

Upon modifications to the draft serialization code, the coediting system increments the iteration version. The coediting system, in one or more examples, does not maintain backward compatibility for deserializing prior iterations of draft serializations, thereby streamlining the development process. By implementing draft serialization support, the coediting system enables engineering teams to rapidly iterate on serialization features, assess a corresponding amount of effectiveness, and prepare the content editing features for production deployment without impacting existing production workflows or incurring undue development overhead.

As shown in FIG. 11, for instance, an example of named content evolution employed as part of document model data structures, specifically showing how previously incompatible content becomes compatible as part of a coediting session. A hierarchical representation of the document model is depicted, starting with “ImageState” at the root, containing a “SheetList” which contains “SheetListEntry” objects and “TSheet” objects. A table is also included with four named content types (e.g., “channels,” “guides,” “frame group,” and “artboards”) and corresponding compatibility states. Each named content has columns indicating whether it “Has ES” (Edit Serialization), whether “ES Enabled” is true/false, and its resulting “LCE Compatible” status, i.e., for “Live Collaborative Editing.”

In this way, the coediting system is configurable to implement content compatibility detection to ensure client devices collaborate solely on items of digital content (e.g., documents) containing content that supports coediting. The coediting system, for instance, divides unsupported content types of elements of the document model into logical pieces, each assigned a unique name. For each piece of named content, the coediting system employs a detector module capable of inspecting document states to identify the presence of specific content types. The coediting system executes these named content detector modules to determine the existence of named content within digital content, enabling appropriate blocking of coediting workflows when incompatibilities are detected, i.e., execution of the workflow ceases.

The coediting system, for instance, categorizes named content based on edit serialization support status, examples of which include “enabled,” “disabled,” or “unsupported.” “Enabled” status signifies full coediting compatibility, exempting the associated detector from compatibility checks. “Disabled” status indicates “consume solely” compatibility, with the detector executed solely when evaluating document conversion to coediting format or content introduction into coediting documents. “Unsupported” status denotes coediting incompatibility, and therefore causes detector execution for each of the content detector modules for compatibility checking workflows.

To accommodate document model expansion over time, the coediting system is configurable to implement a mechanism to restrict “older” client devices (e.g., having older code versions) from collaborating on items of digital content containing unrecognized content. During document saving operations, for instance, the coediting system executes each of the named content detector modules on respective client devices and records a comprehensive list of detected named content within the digital content. Upon opening the digital content, the coediting system directs client devices to examine the recorded list for unfamiliar entries. The presence of unknown entries prompts the coediting system to designate the digital content as incompatible for coediting on that particular client device, maintaining collaborative integrity across varying client device capabilities.

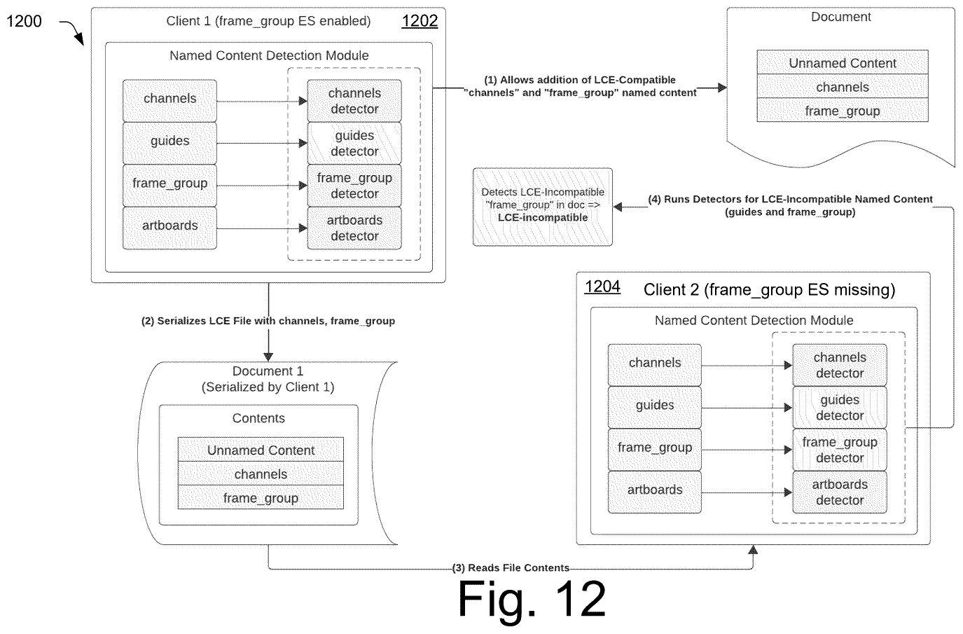

FIG. 12 depicts an architecture 1200 configured to support a change in classification of previously incompatible digital content to compatible digital content. The architecture 1200 includes a first client device 1202 and a second client device 1204 with different configurations. The first client device 1202 has “frame_group ES” enabled whereas the second client device 1204 is missing this content editing feature. Each client device contains a named content detection module that includes detector modules for various content types, e.g., “channels,” “guides,” “frame group,” and “artboards” as previously described.

In this architecture 1200, the first client device 1202 serializes LCE files with channels and frame group content (shown in step 2), creating Document 1 with that content. When the second client device 1204 attempts to read this file (step 3), its named content detection module runs detectors for LCE-incompatible named content (step 4), specifically detecting that “frame group” is LCE-incompatible due to missing edit serialization. The document structure is represented as showing a distinction between unnamed content (e.g., “channels,” “frame group”) and overall document organization.

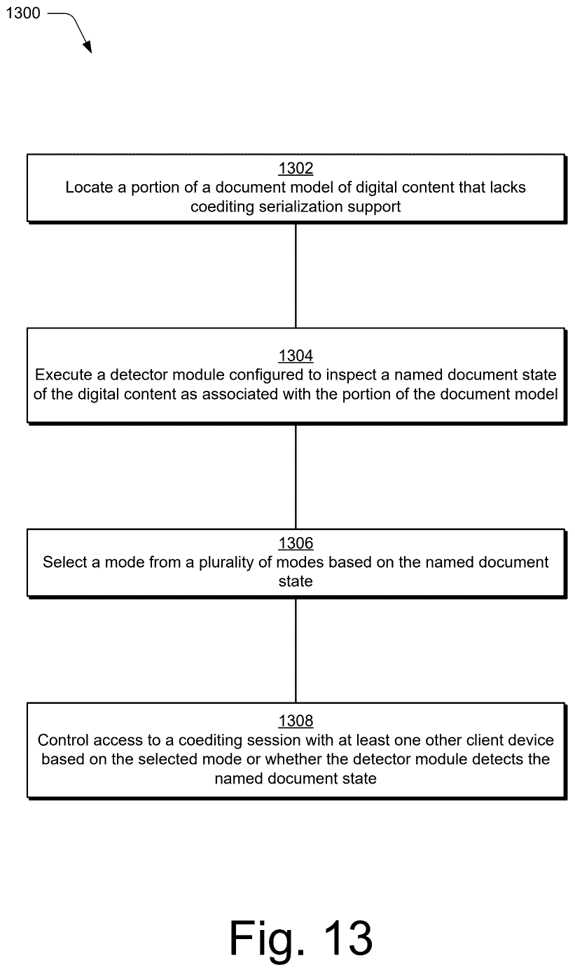

FIG. 13 is a flow diagram depicting an algorithm 1300 as a step-by-step procedure in an example implementation of operations performable for accomplishing a result of mode implementation based on detector modules to control interaction with a coediting session. The coediting system locates a portion of a document model of digital content that lacks coediting serialization support (block 1302). The coediting system may employ a document model analysis module to examine the structure and components of the digital content. This process may involve traversing the document object model or data structure representing the content, identifying elements or sections that do not have implemented serialization support for collaborative editing. The coediting system may maintain a registry of supported content types and compare each portion of the document model against this registry to determine areas lacking coediting compatibility.

In responsive, the coediting system executes a detector module configured to inspect a named document state of the digital content as associated with the portion of the document model (block 1304). The coediting system may utilize a detector configuration module to create specialized inspection tools for each identified unsupported portion of the document model. These detector modules may be designed to recognize specific named content types, such as “channels,” “guides,” “frame_group,” or “artboards,” within the digital content. The coediting system may configure each detector module with criteria and algorithms tailored to identify and assess the state of its corresponding named content type within the context of the document model.

The coediting system then selects a mode from a plurality of modes based on the named document state (block 1306). The coediting system may employ a mode selection module to determine the appropriate operational mode for handling the detected named content. The coediting system may consider factors such as the presence of edit serialization support, whether such support is enabled, and the overall compatibility status of the named content. Based on these considerations, the coediting system may choose from modes such as “enabled support” (indicating full coediting compatibility), “disabled support” (allowing read-only access), or “no support” (signaling complete incompatibility with coediting).

A coediting system controls access to a coediting session with at least one other client device based on the selected mode or whether the detector module detects the named document state (block 1308). The coediting system may utilize an access control module to manage participation in the collaborative editing session. If the selected mode indicates full compatibility, the coediting system may allow unrestricted access to the coediting session. For disabled support mode, the coediting system may permit view-only access while preventing edits to the incompatible content. In scenarios in which support unavailable or incompatible named content is detected, the coediting system may block access to the coediting session entirely, potentially displaying warnings or prompts to the user about the incompatibility issues.

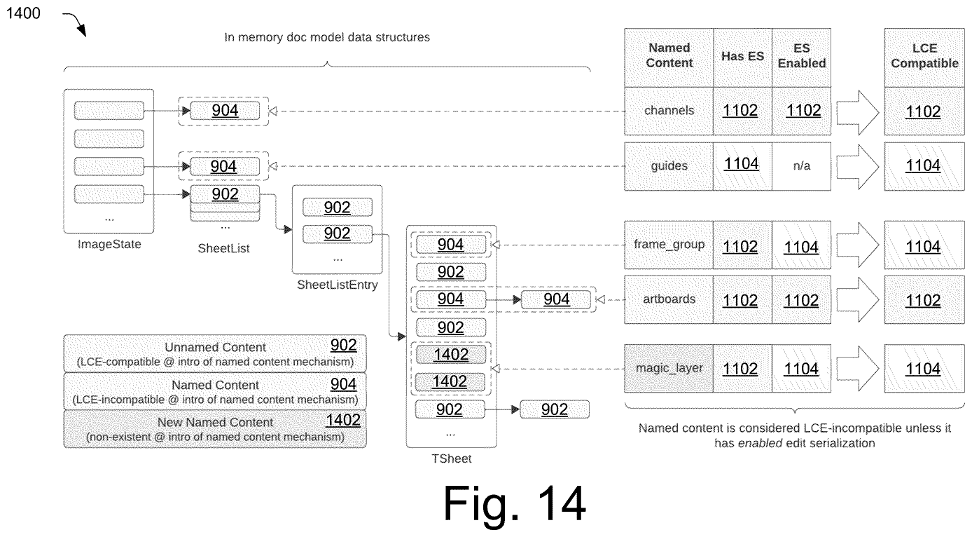

FIG. 14 depicts an architecture 1400 configured to support an evolving document model as part of named content evolution. In one or more implementations, the coediting document model support evolves over time through an expansion of named content supported by the coediting system. To restrict older client devices from coediting documents containing newer, unfamiliar content or content that may be inadvertently discarded upon opening, a detection mechanism is implemented in this example. This mechanism is configurable to allow client devices to identify unknown content added to digital content that is included in a coediting session by newer client devices and treat such content as incompatible, thereby blocking coediting operations.

To achieve this functionality, the coediting system implements several features. First, addition or modification to the document model is associated with a new content name. Second, a list of detected named content is written to coediting documents during a “save” process. Third, when opening digital content, the coediting system reads the list of named content and unrecognized names in this list are interpreted as indicators of incompatibility. The implementation of this approach is illustrated through the example of the new “magic_layer” named content in FIG. 14, which expands upon the previously established diagram.

The architecture 1400 as illustrated depicts named content evolution in a document model for coediting compatibility. A hierarchical structure is again shown of a document model, starting with “ImageState” which contains a “SheetList” that holds “SheetListEntry” objects, which in turn contain “TSheet” objects. The architecture 1400 also distinguishes between unnamed content 902, named content 904, and new named content 1402. A table is also including showing different types of content (e.g., “channels,” “guides,” “frame group,” “artboards,” “magic_layer”) and associated properties, e.g., whether “Has ES” (Edit Serialization) if “ES Enabled” and whether “LCE Compatible.”

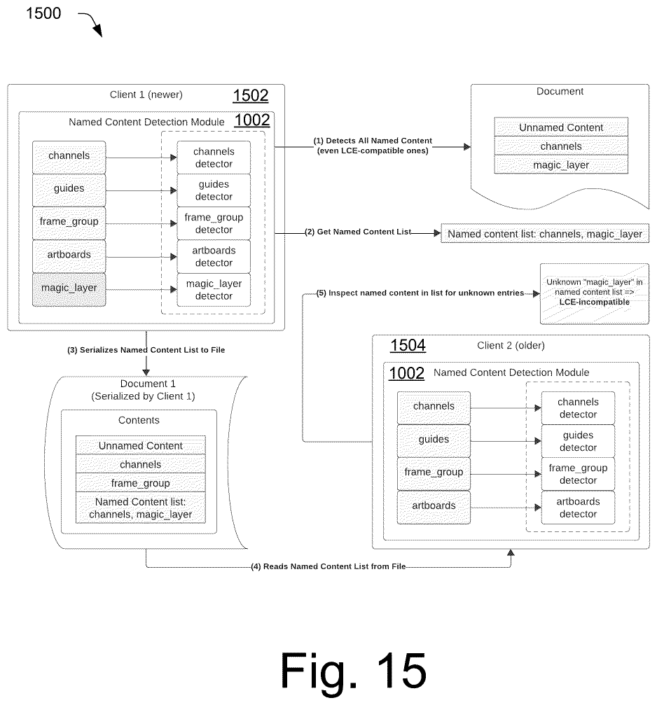

FIG. 15 depicts an architecture 1500 configured to support ceasing loading and execution of digital content upon detecting unknown named content. The named content detection module is employed in this example to determine compatibility between different client versions in a document coediting scenario. Two client devices are shown, a first client device 1502 supporting “newer” content editing functionality and a second client device 1504 supporting “older” content editing functionality. The detector modules of content detection module 1002 of the first client device 1502 contains detector modules as subcomponents generated for various content types including “channels,” “guides,” “frame group,” “artboards,” and “magic_layer.”

The implementation example is depicted showing a sequence of steps: (1) detecting named content, (2) getting the named content list from the document, (3) serializing the named content list to a file, and (4) reading the named content list from the file by the older client. In this way, the second client device 1504 identifies incompatible content by inspecting the named content list for unknown entries, e.g., as illustrated “magic_layer” is LCE-incompatible since this feature is unknown to the second client device 1404.

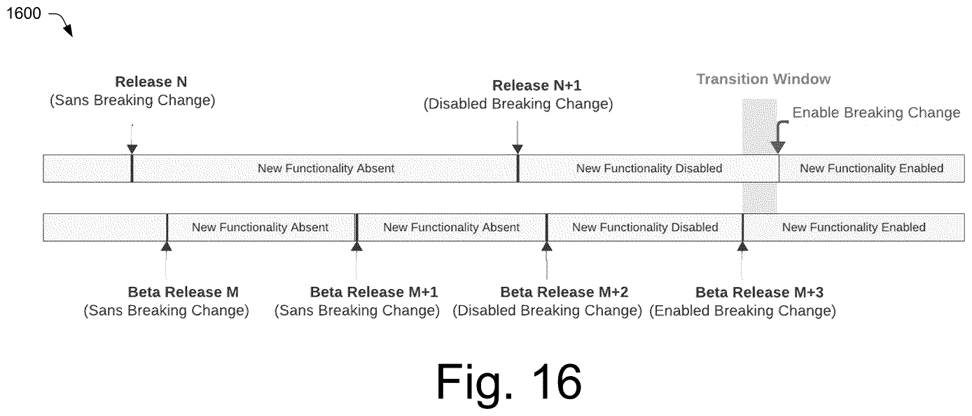

FIG. 16 depicts a timeline progression 1600 showing release coordination involving a coordinated release of a breaking change involving producer and consumer releases. In this example, a coordinated release strategy is depicted for managing breaking changes across different software versions, specifically showing a relationship between producer and consumer releases.

The timeline progression 1600 starts with “Release N” and “Beta Release M” extending through several releases. To begin, release N, marked as “Sans Breaking Change,” is followed by “Release N+1” where the breaking change is released in a disabled state and “Beta Release M” is followed by “Beta Release M+1” and “Beta Release M+2” where the breaking change is released in a disabled state in the latter. This is followed by “Beta Release M+3” where the breaking change is enabled.

A “Transition Window” follows, terminating when the breaking change is enabled in “Release N+1” via remote feature enablement. The timeline progression 1600 shows four sequential beta releases (e.g., “M” through “M+3”), demonstrating the gradual implementation of the new functionality. Beta release “M” and “M+1” show the functionality as absent, “M+2” shows the functionality as disabled, and subsequently “M+3” shows the functionality as enabled. Throughout the sequence, the status of the new functionality is indicated as transitioning from “Absent” to “Disabled” to “Enabled.” The transition window is enabled by the transition builds being simultaneously compatible with both the prior builds without the new capability and the newer builds with the new capability enabled and relieves tasks from being forced to enable new functionality in perfect synchronization across multiple platforms.

### Client Device Deprecation and Expiration

The following discussion describes client device deprecation and expiration techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

In this section, techniques are described for deprecating and disabling coediting support in older client devices. Considerations for these techniques include policy implications, handling in-session client devices during support termination, addressing older client devices catching up during policy changes, analyzing potential race conditions, and leveraging version information for session connection and delta submission control.

Practical considerations for discontinuing backward compatibility for deltas include reducing a technical debt by removing outdated code and library dependencies, eliminating document model functionalities, and limiting support for older builds to align with institutional policies. When support is discontinued, for instance, it is desirable for outdated client devices to recognize an unsupported status, thereby preventing submission of incompatible deltas. Additionally, implementing a deprecation period supports display of appropriate warning to older client devices.

Accordingly, to address these and other technical challenges, a “no write version” technique is introduced that is incremented when backward compatibility support is discontinued. The service provider system 102, for instance, advertises two key version thresholds: a “Recommended No Write” version and a “Required No Write” version. These thresholds serve to identify deprecated and unsupported client devices, respectively.

Client devices with a “No Write Version” below the broadcast “Recommended No Write” version are classified as deprecated. These client devices then present an appropriate warning via a user interface, indicating update desirability. When a client device's “No Write” version falls below the “Required No Write” version advertised by the service provider system 102, it is deemed unsupported. In this scenario, the client device displays a warning in a user interface and prevents coediting functionality. As a result, this technique allows for a gradual transition, first alerting users of deprecated client devices to encourage updates, and then blocking coediting on unsupported devices to maintain system integrity and compatibility.

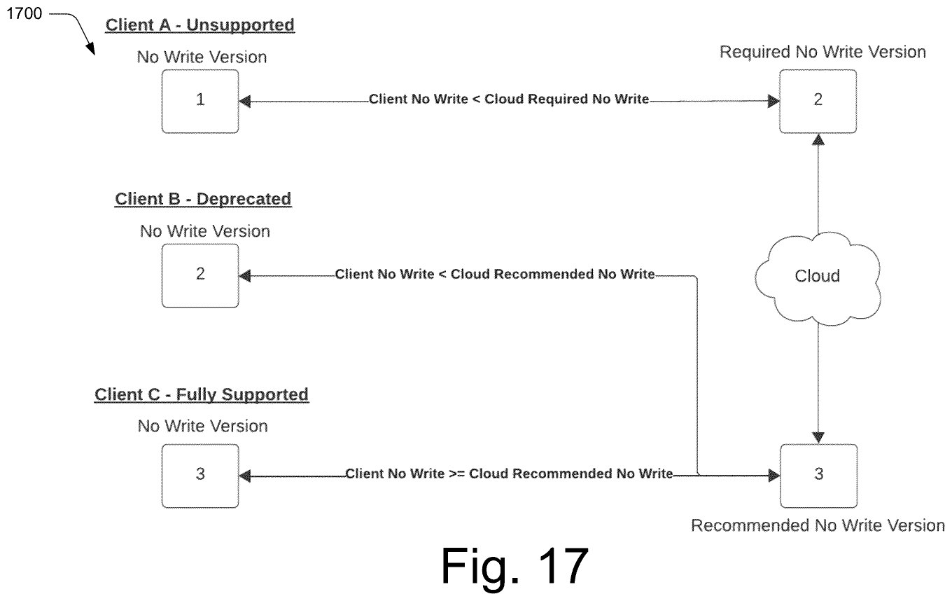

FIG. 17, for instance, depicts an example implementation 1700 of a deprecation and expiration technique for client device support in a coediting system. Three different client device scenarios are depicted based on respective “No Write Version” numbers. Client A (version 1) is marked as “Unsupported,” Client B (version 2) is marked as “Deprecated,” and Client C (version 3) is marked as “Fully Supported.”

A cloud component of the service provider system 102 manages two key version thresholds. A first “Required No Write Version” set to 2 and a second “Recommended No Write Version” set to 3. When a client device's “No Write” version is less than the “Required No Write” version (e.g., Client A), the client device is considered unsupported. When it matches or exceeds the “Required” version but is less than the “Recommended” version (e.g., Client B), the client device is deprecated. Clients with versions matching or exceeding both thresholds (e.g., Client C) are fully supported.

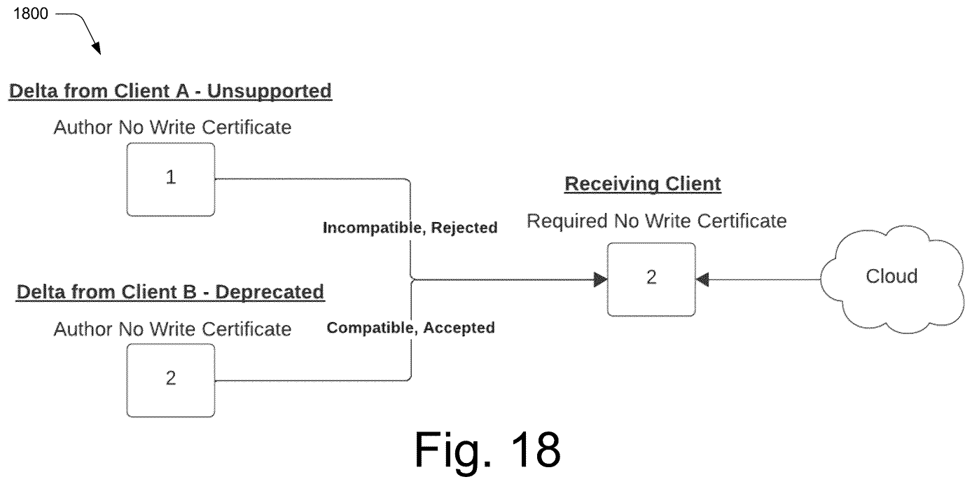

FIG. 18 depicts another example implementation 1800 of a deprecation and expiration technique for client device support in a coediting system. In an implementation, unsupported client devices do not send deltas, and client devices (along with deployed synchronization module 602) which have discontinued certain backward compatibility features do not encounter non-compliant deltas. However, two scenarios may lead to such encounters. In a first scenario, existing client devices lacking the described mechanism do not self-restrict from sending deltas based on version compatibility. In a second scenario, the coediting system initiates the synchronization module 602 to retry failed delta compaction attempts.

To safeguard against these scenarios and enable newer client devices and the synchronization module 602 to reject incompatible deltas, two techniques may be implemented. In a first example, an “Author No Write” version is encoded within deltas, defaulting to zero if absent. Additionally, deltas with an “Author No Write” version incompatible with the service provider system 102 advertised “Required No Write” version are rejected. This technique allows the synchronization module 602 to halt retry attempts for incompatible deltas.

As shown in FIG. 18 for instance, a delta version compatibility checking mechanism is depicted between client devices in a coediting system. In a first scenario, Client A with an “Author No Write” value of “one: attempts to send a fingerprint (e.g., delta), but it is rejected as incompatible by the Receiving Client which has a “Required No Write Certificate” value of two. In the second scenario, Client B with an “Author No Write Certificate” value of two sends a delta which is accepted as compatible by the Receiving Client. In this way, the coediting system enforces version compatibility between client devices by comparing respective “No Write Certificate” values.

The techniques described herein implement a deprecation and expiration process involving several steps to phase out support for older features or content encodings. Initially, a new client device (i.e., a new version of a first client coedit module 132) is released that can read but not write the deprecated content, incrementing its “No Write” version accordingly. This updated client device effectively indicates “it no longer writes” the deprecated feature.

After the new client device has been implemented, the service provider system 102 updates the “Recommended No Write” version. This action signals to older client devices that unless those client devices have ceased writing this content feature, client devices and corresponding client coediting modules are considered deprecated. At this stage, older client devices are configurable to display warnings to users, encouraging them to upgrade to the latest version.

Following a transition period, the “Required No Write” version advertised by the service provider system 102 is updated. This change informs client devices that unless they have stopped utilizing this feature, these client devices are no longer supported. Older client devices can then notify users that an upgrade is requested in order to continue coediting, and subsequently block editing and submission of deltas. After an interval of time, updated client devices can be released and an updated synchronization module 602 can be deployed. These updates remove an ability to read the deprecated content, as no deltas containing such content are expected to be submitted at this point. A variety of other examples are also contemplated.

### Offline Editing of Collaborative Digital Content

The following discussion describes offline editing of collaborative digital content techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

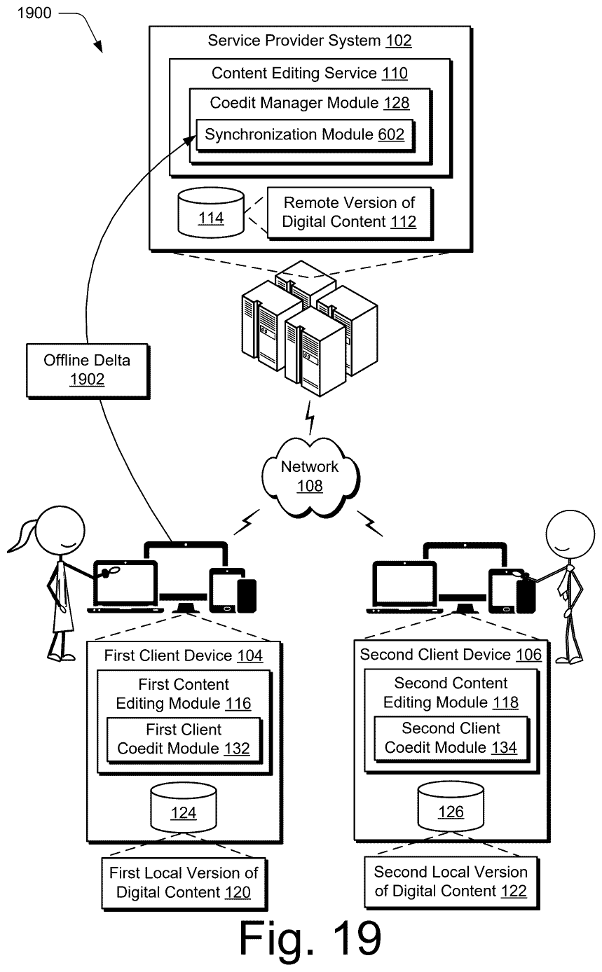

FIG. 19 depicts a system 1900 in an example implementation depicting techniques for offline editing of digital content that is shared as part of a coediting session. The coediting system as implemented by the synchronization module 602 of the coedit manager module 128 as well as the first client coedit module 132 and second client coedit module 134 facilitates offline editing of collaborative digital content by implementing an opportunistic synchronization mechanism. The coediting system allows modifications to digital content while offline, preserving both original and edited versions upon digital content and/or application closure. Subsequently, the coediting system prepares the edited version for synchronization via a background process, which activates upon device reconnection to share an offline delta 1902, independent of a primary editing application's status, i.e., the content editing module. The background process employs a generic approach, managing file uploads with basic if/match conflict detection. In scenarios without concurrent edits during the offline period, the background synchronization completes successfully, updating the cloud version for access by other client devices.

When an if/match conflict occurs due to changes from other client devices, the coediting system is configurable to initiate a three-way merge process upon document reopening. The merge operation, in one or more examples, utilizes an original (base) version, the locally modified version, and the latest cloud version of the digital content. The coediting system can generate incremental deltas describing the offline change by inspecting the contents of the base and modified versions to employ an incremental, delta-based synchronization method to integrate offline edits into the shared cloud document. By combining generic file-based synchronization with incremental delta synchronization, the coediting system achieves rapid offline change integration when conflicts are absent while maintaining capability for sophisticated merging upon document reopening.

The coediting system's approach to offline editing and synchronization enhances collaborative workflows by enabling seamless work in disconnected environments. Through implementation of background synchronization and conflict resolution mechanisms, the coediting system minimizes disruptions to productivity and ensures data consistency across multiple editing sessions and client devices. The coediting system's ability to perform both immediate background synchronizations and delayed sophisticated merges provides a flexible and robust solution for managing offline edits in collaborative document environments.

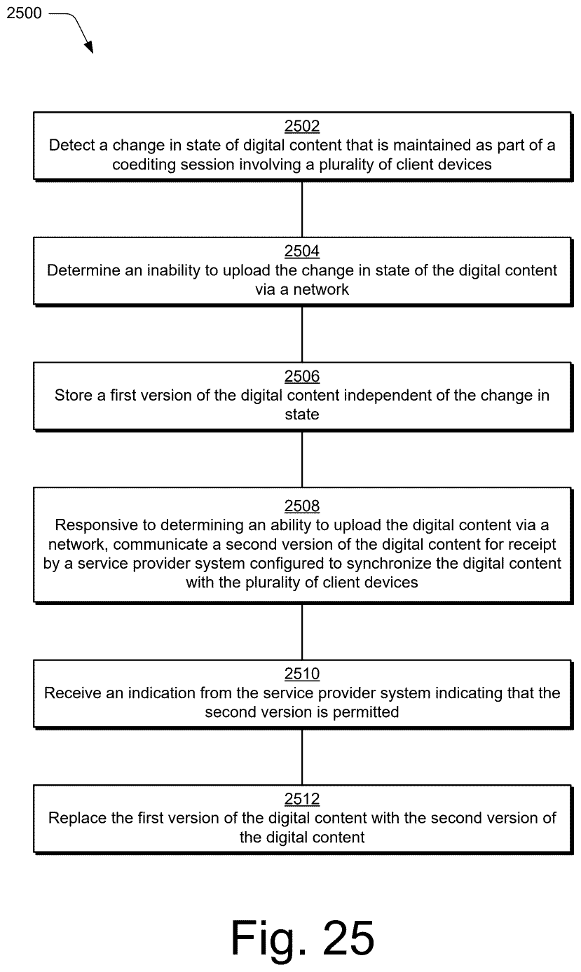

FIG. 25 is a flow diagram depicting an algorithm 2500 as a step-by-step procedure in an example implementation of operations performable for accomplishing a result of offline synchronization as part of collaborative editing. A coediting system detects a change in state of digital content that is maintained as part of a coediting session involving a plurality of client devices (block 2502). The coediting system may employ an edit input module to receive and process modifications made to the digital content during offline editing. These changes may include alterations to text, images, layers, or document structure. The coediting system may track these modifications locally, maintaining a record of the evolving state of the digital content even when disconnected from the network.

The coediting system then determines an inability to upload the change in state of the digital content via a network (block 2504). The coediting system may utilize a network connectivity module to assess the current state of network connectivity. If a connection to the service provider system is unavailable or unstable, the coediting system recognizes that immediate synchronization with other client devices in the coediting session is not currently possible. This determination triggers the coediting system to initiate offline handling procedures for the detected changes.

In response, the coediting system stores a first version of the digital content independent of the change in state (block 2506). The coediting system may use a version management module to create and maintain a separate copy of the digital content that reflects its state prior to the offline changes. This unmodified version may be stored in local storage, potentially alongside metadata indicating its relationship to the current editing session. Preserving this version allows for potential conflict resolution or rollback operations when network connectivity is restored.

The coediting system, responsive to determining an ability to upload the digital content via a network, communicates a second version of the digital content for receipt by a service provider system configured to synchronize the digital content with the plurality of client devices (block 2508). The coediting system may employ a background synchronization process to detect when network connectivity is reestablished. Upon detecting a stable connection, the coediting system initiates the transmission of the stored version to the service provider system. This communication may occur independently of the primary editing application's status, allowing for opportunistic synchronization.

The coediting system then receives an indication from the service provider system indicating that the change in state to the digital content is permitted (block 2510). The coediting system may utilize a response handling module to process the feedback from the service provider system. This indication may signify that the offline changes have been successfully integrated into the shared version of the digital content, or that no conflicts were detected with changes made by other client devices during the offline period. The coediting system may interpret this indication as authorization to finalize the local changes.

The coediting system may also replace the first version of the digital content with the second version of the digital content (block 2512) having the change in state. This process may involve overwriting the previously stored unmodified version with the version containing the offline changes. By completing this replacement, the coediting system ensures that the local instance of the digital content is now consistent with the synchronized state across the coediting session, reflecting the successfully integrated offline modifications. In an implementation, if a service provider system reports that a wholesale upload of not permitted, then the coediting system generates deltas describing a change between a base version of the digital content and locally modified version. The delta-based synchronization technique is then utilized at a subsequent point in time, e.g., a next time an editing application is opened. In this way, use of deltas operates as a fallback when a wholesale version update detects a conflict, e.g., a mismatch.

### Edit History for Collaborative Digital Content

The following discussion describes techniques involving an edit history for collaborative digital content that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

The coediting system is also configurable to implement a variety of edit history enhancements. The coediting system, for instance, implements cloud-based persistent edit history functionality to enhance collaborative document editing. The coediting system stores deltas, representing incremental document changes, and periodic asset versions, capturing full document states after edit sets, in cloud storage. When a client device requests an edit history that is unavailable locally (e.g., from previous editing sessions or collaborator edits prior to joining), for instance, the coediting system loads an asset version at or before the desired history state. The coediting system then retrieves and applies subsequent deltas to reconstruct the edit history. The reconstructed history becomes accessible through standard history user interfaces, including history scrubbing features.

For local document editing, the coediting system extends persistent history support by leveraging the coediting delta mechanism. During local file editing, the coediting system generates “reverse” deltas, representing changes from post-edit to pre-edit states. The coediting system stores these reverse deltas within or alongside the local file during save operations, or in a device cache upon generation. When reopening a file, the coediting system locates available reverse deltas and applies the reverse deltas to the digital content from newest to oldest, recreating older edit history states in reverse chronological order.

The coediting system's persistent edit history functionality addresses limitations of conventional editing techniques, where edit history typically vanishes upon document closure or becomes limited due to performance constraints. By implementing cloud-based storage for collaborative documents and reverse delta generation for local files, the coediting system provides enhanced edit history persistence across various editing scenarios, improving user experience and workflow continuity.

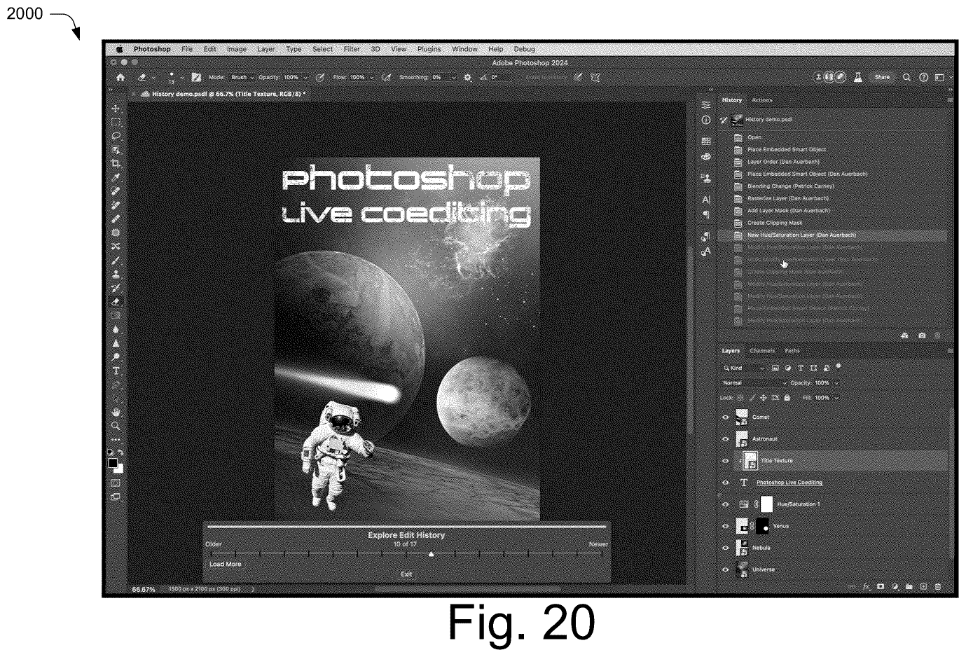

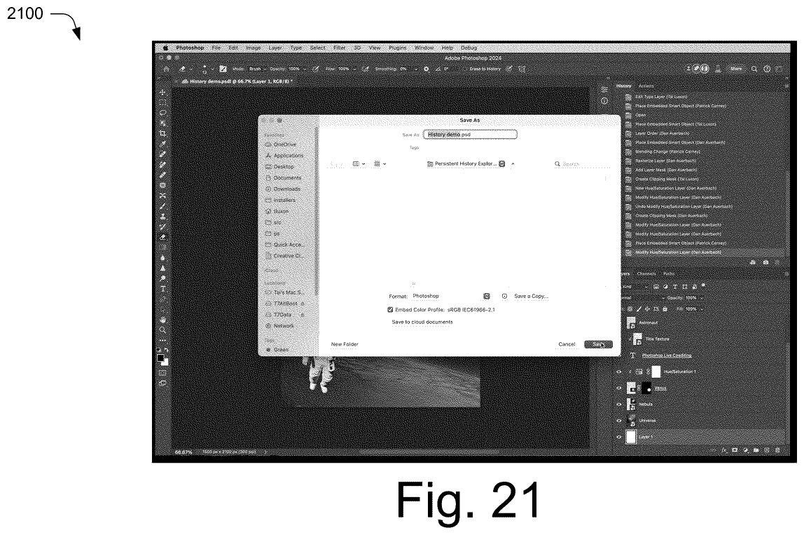

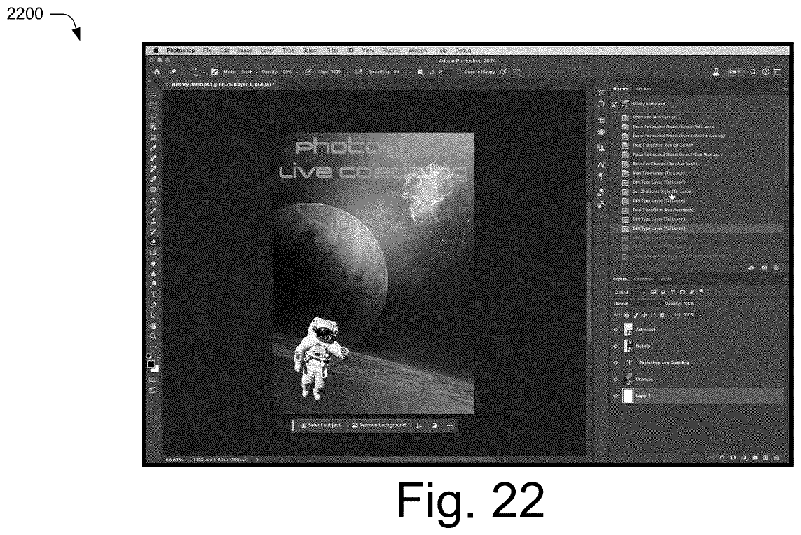

FIGS. 20, 21, and 22 depict examples 2000, 2100, 2200 of user interface in example implementations of involving an edit history for collaborative digital content that are implementable utilizing the described systems and devices. In a typical non-collaborative editing session, users can go back in time by selecting different history states and thereby see the evolution of digital content. Users can even choose to go in a different direction by making an edit based on one of these states. However, in a real-time coediting session having multiple collaborating client devices, additional synchronization challenges arise. For example, navigating back in a history is typically disruptive.

Accordingly, techniques are described that support history navigation without disrupting editing during a coediting session. The coediting system, in the illustrated examples, implements an explore edit history mode when a user selects a history state. In this mode, users may preview old history states and copy content, but editing is disabled to prevent disruption to collaborators. The coediting system provides a slider interface that allows users to visually scrub through history states, enabling efficient visualization of document evolution over time.

The coediting system also supports loading additional history from before the current editing session began. As the digital content is part of a live coediting session, the coediting system retains edits from each of collaborators in cloud storage of the service provider system 102 for a period of time. Users may load these earlier edits to view changes made by collaborators while the digital content was closed on a local device, and visually scrub through the edit history to examine specific modifications.

Additionally, the coediting system implements persistent edit history functionality that extends across multiple editing sessions. When a user saves the digital content as a local file (e.g., a PSD file) on their device, closes the file, and later reopens it, the coediting system retrieves and presents the same edit history from the previous session. This feature allows users to maintain continuity in an editing workflow across different sessions.

### Example System and Device

FIG. 27 illustrates an example system generally at 2700 that includes an example computing device 2702 that is representative of one or more computing systems and/or devices that implement the various techniques described herein. This is illustrated through inclusion of the content editing service 110 a client coedit module 2720 representative of either the first client coedit module 132 or the second client coedit module 134. The computing device 2702 is configurable, for example, as a server of a service provider, a device associated with a client (e.g., a client device), an on-chip system, and/or any other suitable computing device or computing system.

The example computing device 2702 as illustrated includes a processing device 2704, one or more computer-readable media 2706, and one or more I/O interface 2708 that are communicatively coupled, one to another. Although not shown, the computing device 2702 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 2704 is representative of functionality to perform one or more operations using hardware. Accordingly, the processing device 2704 is illustrated as including hardware element 2710 that is configurable as processors, functional blocks, and so forth. This includes implementation in hardware as an application specific integrated circuit or other logic device formed using one or more semiconductors. The hardware elements 2710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 2706 is illustrated as including memory/storage 2712 that stores instructions that are executable to cause the processing device 2704 to perform operations. The computer-readable storage medium is configured for storing instructions that, responsive to execution by the processing device, causes the processing device to perform operations. The memory/storage 2712 represents memory/storage capacity associated with one or more computer-readable media. The memory/storage 2712 includes volatile media (such as random access memory (RAM)) and/or nonvolatile media (such as read only memory (ROM), Flash memory, optical disks, magnetic disks, and so forth). The memory/storage 2712 includes fixed media (e.g., RAM, ROM, a fixed hard drive, and so on) as well as removable media (e.g., Flash memory, a removable hard drive, an optical disc, and so forth). The computer-readable media 2706 is configurable in a variety of other ways as further described below.

Input/output interface(s) 2708 are representative of functionality to allow a user to enter commands and information to computing device 2702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 2702. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 2702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2710 and computer-readable media 2706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 2710. The computing device 2702 is configured to implement particular instructions and/or functions corresponding to the software and/or hardware modules. Accordingly, implementation of a module that is executable by the computing device 2702 as software is achieved at least partially in hardware, e.g., through use of computer-readable storage media and/or hardware elements 2710 of the processing device 2704. The instructions and/or functions are executable/operable by one or more articles of manufacture (for example, one or more computing devices 2702 and/or processing devices 2704) to implement techniques, modules, and examples described herein.

The techniques described herein are supported by various configurations of the computing device 2702 and are not limited to the specific examples of the techniques described herein. This functionality is also implementable all or in part through use of a distributed system, such as over a “cloud” 2714 via a platform 2716 as described below.

The cloud 2714 includes and/or is representative of a platform 2716 for resources 2718. The platform 2716 abstracts underlying functionality of hardware (e.g., servers) and software resources of the cloud 2714. The resources 2718 include applications and/or data that can be utilized while computer processing is executed on servers that are remote from the computing device 2702. Resources 2718 can also include services provided over the Internet and/or through a subscriber network, such as a cellular or Wi-Fi network.

The platform 2716 abstracts resources and functions to connect the computing device 2702 with other computing devices. The platform 2716 also serves to abstract scaling of resources to provide a corresponding level of scale to encountered demand for the resources 2718 that are implemented via the platform 2716. Accordingly, in an interconnected device embodiment, implementation of functionality described herein is distributable throughout the system 2700. For example, the functionality is implementable in part on the computing device 2702 as well as via the platform 2716 that abstracts the functionality of the cloud 2714.

In implementations, the platform 2716 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
locating, by a processing device, a portion of a document model of digital content that lacks coediting serialization support;
executing, by the processing device, a detector module configured to inspect a named document state of the digital content as associated with the portion of the document model;
selecting, by the processing device, a mode from a plurality of modes based on the named document state; and
controlling, by the processing device, access to a coediting session with at least one other client device based on the selected mode or whether the detector module detects the named document state.

2. The method as described in claim 1, wherein the selected mode is an enabled support mode indicating the digital content is coediting compatible.

3. The method as described in claim 1, wherein the selected mode is a disabled support mode indicating coediting of the digital content is not permitted and output of the digital content for viewing is permitted.

4. The method as described in claim 1, wherein the selected mode is a no support mode indicating coediting of the digital content is not permitted and output of the digital content for viewing is permitted.

5. The method as described in claim 1, wherein the controlling includes exiting the coediting session responsive to detecting a delta and a fingerprint as associated with the named document state.

6. The method as described in claim 5, wherein the fingerprint is generated by locating one or more elements of the digital content corresponding to a change in state described by the delta and generating the fingerprint based on a hash of a serialization of the one or more elements of the delta.

7. The method as described in claim 6, wherein the delta includes a version identifier as indicating a version associated with a content editing feature.

8. The method as described in claim 7, wherein the version identifier is usable as part of determining compatibility with the change in state.

9. The method as described in claim 6, wherein the serialization is generated based on an in-memory stream of the one or more elements of the delta.

10. The method as described in claim 5, wherein the fingerprint is generated by identifying session-dependent data and controlling whether to omit the session-dependent data from the fingerprint.

11. One or more computer-readable storage media storing instructions that, responsive to execution by a processing device, causes the processing device to perform operations comprising:
detecting, by a service provider system as part of a coediting session, a mismatch based on a first fingerprint generated as describing a change in state of digital content that is maintained as part of a coediting session locally by a first client device;
resolving, by the service provider system, the mismatch based on the fingerprint and a second fingerprint generated by a second client device as part of the coediting session; and
communicating, by the service provider system, a result of the resolving to the first client device.

12. The one or more computer-readable storage media as described in claim 11, wherein the result includes a delta.

13. The one or more computer-readable storage media as described in claim 12, wherein the result causes the first client device to remove the change in state of the digital content as maintained locally by the first client device.

14. The one or more computer-readable storage media as described in claim 11, wherein the first fingerprint is generated by locating one or more elements of the digital content corresponding to the change in state, generating the fingerprint based on a hash of a serialization of the one or more elements.

15. The one or more computer-readable storage media as described in claim 11, wherein the generating of the fingerprint includes identifying session-dependent data associated with the change in state and omitting the session-dependent data from the fingerprint.

16. The one or more computer-readable storage media as described in claim 11, wherein the first fingerprint includes a version identifier identifying a version of a content editing feature associated with the change in state.

17. The one or more computer-readable storage media as described in claim 16, wherein the version identifier is usable as part of determining compatibility with the change in state.

18. A client device comprising:
a processing device; and
a computer-readable storage medium storing instructions that, responsive to execution by the processing device, causes the processing device to perform operations including:
locating a portion of a document model of digital content that lacks coediting serialization support;
executing a detector module configured to inspect a named document state of the digital content as associated with the portion of the document model;
selecting a mode from a plurality of modes based on the named document state; and
control access to a coediting session with at least one other client device based on the selected mode or whether the detector module detects the named document state.

19. The client device as described in claim 18, wherein the selected mode is:
an enabled support mode indicating the digital content is coediting compatible;
a disabled support mode indicating coediting of the digital content is not permitted and output of the digital content for viewing is permitted; or
a no support mode indicating coediting of the digital content is not permitted and output of the digital content for viewing is permitted.

20. The client device as described in claim 18, wherein the controlling includes exiting the coediting session responsive to detecting a delta and a fingerprint as associated with the named document state.
